(19) United States
(12) Patent Application Publication
(10) Pub. No.: US 2026/0278168 A1
(43) Pub. Date: Sep. 17, 2026

(54) DATA INSIGHT AND EXPLORATION WITH NATURAL LANGUAGE QUERIES

(71) Applicant: Wells Fargo Bank, N.A., San Francisco, CA (US)

(72) Inventor: Lit Jeh Lim, Oakland, CA (US)

(21) Appl. No.: 19/568,491

(22) Filed: Mar. 16, 2026

Related U.S. Application Data
(60) Provisional application No. 63/773,244, filed on Mar. 17, 2025.

(51) Int. Cl. G06F 21/62; G06F 16/3329; G06F 16/334

(52) U.S. Cl. CPC G06F 21/6254; G06F 16/3329; G06F 16/3344

(57) ABSTRACT

Certain aspects of the disclosure pertain to natural language data exploration. A computing system may manage a data catalog integrating diverse data sources. To facilitate intelligent exploration of this data, the system can utilize a multi-agent architecture. An orchestration agent can obtain a natural language query, interpret a semantic intent, and determine an execution strategy by selecting and sequencing specialized execution agents. The orchestration agent routes execution parameters to the selected agents and combines their analytical results. Furthermore, prior to user presentation, the orchestration agent can intercept retrieved data and transmit the data to a security agent to evaluate user access rights against real-time security conditions. A formulated response is then output based on this evaluation, enabling secure and orchestrated data insights.

### CROSS REFERENCE TO RELATED APPLICATIONS

This application claims the benefit of and priority to U.S. Provisional Patent Application No. 63/773,244, filed Mar. 17, 2025, and entitled “Data Insight and Exploration with Natural Language Queries,” the entirety of which is incorporated herein by reference.

### TECHNICAL FIELD

Aspects of the subject disclosure relate to distributed database access and, more specifically, to multi-agent orchestration systems for natural language processing.

### BACKGROUND

Data insight refers to actionable intelligence gained from analyzing raw data. Trends, patterns, and correlations can be determined to inform decision-making. Data insight can be exploited to improve operations, enhance customer experience, or both. Various methods can generate data insight including statistical analysis and data visualization, which frequently involve interacting with data storage systems as enterprise computing environments grow in scale.

### SUMMARY

The following summary provides a basic understanding of some aspects of the disclosed subject matter. This summary is not an extensive overview. It is not intended to identify key elements or to delineate the scope of the claimed subject matter. Its sole purpose is to present some concepts in a simplified form as a prelude to the more detailed description presented later.

In brief, aspects of the subject disclosure pertain to a conversational data exploration and insight system that utilizes a multi-agent artificial intelligence architecture to democratize access to enterprise information. A user provides a natural language request through a chatbot interface, and an orchestration agent interprets the intent of the request to route the request to one or more specialized execution agents. For structured data queries, an exploration agent translates the natural language into executable database queries, extracts the requested information, and generates analytical insights. Other specialized agents handle additional tasks, which include analyzing data health, searching unstructured document repositories, and logging system interactions. Before presenting any results to the user, a security agent can evaluate the retrieved data against the access rights associated with the user to ensure compliance with privacy and security requirements. If the user lacks the necessary access rights, an intake agent initiates an interactive workflow to request approval. By automating retrieval, routing, and governance processes, the architecture streamlines data discovery and analysis while reducing reliance on specialized technical skills.

Certain aspects provide a method for accessing data, the method comprising obtaining a natural language query, invoking a computing system executing at least one machine learning model to analyze the natural language query to determine a semantic meaning, determine at least one target data source based on the semantic meaning, the at least one target data source including at least one of a structured data source or an unstructured data source, generate an executable data query in a data query language based on the at least one target data source and the semantic meaning, submit the executable data query to the at least one target data source, and generate a response to the natural language query, including integrating data obtained from the at least one target data source, and outputting the response.

Certain aspects provide a system, comprising at least one processor implemented in circuitry, and at least one memory coupled to the at least one processor that stores instructions that, when executed by the at least one processor, cause the system to obtain a natural language query, invoke at least one machine learning model to analyze the natural language query to determine a semantic meaning, determine at least one target data source based on the semantic meaning, the at least one target data source including at least one of a structured data source or an unstructured data source, generate an executable data query in a data query language based on the at least one target data source and the semantic meaning, submit the executable data query to the at least one target data source, and generate a response to the natural language query, including integrating data obtained from the at least one target data source, and output the response.

Certain other aspects provide a computer-readable storage medium comprising instructions that, when executed by at least one processor, cause the at least one processor to obtain a natural language query, invoke at least one machine learning model to analyze the natural language query to determine a semantic meaning, determine at least one target data source based on the semantic meaning, the at least one target data source including at least one of a structured data source or an unstructured data source, generate an executable data query in a data query language based on the at least one target data source and the semantic meaning, submit the executable data query to the at least one target data source, and generate a response to the natural language query, including integrating data obtained from the at least one target data source, and output the response.

Other aspects provide processing systems configured to perform the aforementioned method as well as those described herein; non-transitory, computer-readable media comprising instructions that, when executed by one or more processors of a processing system, cause the processing system to perform the aforementioned method as well as those described herein; a computer program product embodied on a computer-readable storage medium comprising code for performing the aforementioned method as well as those further described herein; and a processing system comprising means for performing the aforementioned method as well as those further described herein.

To accomplish the foregoing and related ends, certain illustrative aspects of the disclosed subject matter are described herein in connection with the following description and annexed drawings. These aspects are indicative of several ways in which the subject matter may be practiced, all of which are intended to be within the scope of the claimed subject matter. Other advantages and features may become apparent from the following detailed description when considered in conjunction with the drawings.

### DESCRIPTION OF THE DRAWINGS

The appended figures depict certain aspects and are therefore not to be considered limiting of the scope of this disclosure.

FIG. 1 is a conceptual diagram illustrating an example system configured to generate a data model that facilitates downstream data insight and exploration, the data model comprising one or more data sources, one or more data use cases, and one or more data governance policies retrieved from one or more of a plurality of data platforms.

FIG. 2 is a block diagram illustrating an example system including vendor and platform-agnostic APIs configured to ingest data.

FIG. 3 is a conceptual diagram illustrating an example system configured to generate, based on the level of quality of a data source, a report indicating the status of the data domain and data use case.

FIG. 4 is a block diagram illustrating an example system configured to manage a data catalog.

FIG. 5 is a flow chart diagram illustrating an example process by which a computing system may evaluate data quality to generate a status report.

FIG. 6 is a block diagram of an example data organization and distribution system.

FIG. 7 is a flow chart diagram of a method of data exploration.

FIG. 8 is a block diagram illustrating an example multi-agent system architecture configured to evaluate natural language queries and route the natural language queries to specialized execution agents.

FIG. 9 is a block diagram illustrating an example technical flow and architecture for implementing a conversational data exploration system.

FIG. 10 is a flow chart diagram illustrating an example method for processing a natural language query, evaluating access rights, and routing an access request to an approval queue using a multi-agent architecture.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the subject disclosure provide apparatuses, methods, processing systems, and computer-readable mediums related to management and interaction with data. More particularly, aspects relate to data insight and exploration.

In large enterprises, data is often fragmented across multiple databases, leading to overlapping, duplicated, or siloed information. These fragmented data environments create significant barriers that hinder seamless access and integration of data, limiting organizations from unlocking the full potential of their data assets.

Furthermore, conventional data exploration and reporting processes are inefficient and hinder productivity and decision-making. Typically, approaches are manual and time-intensive, involving significant effort to research, extract, and create summaries tailored to a specific context and audience. Approaches can involve repetitive ad-hoc requests, which can lead to redundant efforts and an increased risk of missing critical data. Further, reliance on subject matter experts adds complexity as navigating interconnected data environments requires specialized knowledge to deliver accurate results.

In accordance with one aspect, dismantling existing data swim lanes by reducing reliance on rigid, pre-defined data structures enables organizations to extract value directly from the raw data. However, a challenge lies not only in generating actionable insights but in developing a solution that harnesses the intrinsic value of the raw data for broader, enterprise-wide utility. This involves a fundamental shift in how data is accessed, discovered, interpreted, and utilized to uncover deeper opportunities for innovation and efficiency, driving value far beyond conventional analytical approaches.

Aspects disclosed herein provide a computer architecture to support large-scale data exploration through natural language conversations. One or more machine learning models can be employed to support such conversations. In accordance with one aspect, one or more machine learning models can be invoked to perform natural language processing of an input natural language query to determine semantic meaning such as intent and relevant data entries. The same or a different machine learning model can be employed to transform the natural language query into a data query specified in a data query language (e.g., Structured Query Language (SQL)). The data query can be submitted to one or more data storage systems for processing and requested data can be obtained. Subsequently, the same or different machine learning model can be invoked to generate a response to the natural language query. According to one aspect, the response can be a natural language response that integrates obtained data. In other aspects, the response can include a summary of the obtained data, a visual graphic representing the data, or both. In accordance with one embodiment, a visual graphic can be rendered as part of a dashboard.

Although not limited thereto, aspects of this disclosure extend a data management system and build on a data management framework (e.g., automated data management framework (ADMF)) and data catalog (e.g., uniform data catalog (UDC)) as foundation components. Together, the data management framework and data catalog can provide trustworthy data organized, cataloged, and available for analysis. Aspects described herein can rely on the framework and catalog for governed data and metadata to identify relevant data sets. Furthermore, such a data management system can be employed in one aspect to parameterize or inform what systems of record are authoritative sources of data (e.g., trusted information) for use in generating insights and responding to natural language queries.

Aspects of the subject disclosure can democratize data access through natural-language-based data exploration and retrieval without utilizing specialized query skills. Further, integration of disclosed aspects enhances data accessibility and broadens access to data insights across teams.

While foundational data management ensures authoritative sourcing, conventional centralized artificial intelligence (AI) architectures often suffer from high latency and security risks when processing natural language across fragmented enterprise silos. The multi-agent system architecture described herein addresses these technical bottlenecks by transitioning from a monolithic processing model to a distributed orchestration framework. In this architecture, an orchestration agent functions as a high-speed router that isolates cognitive reasoning from specific data retrieval tasks.

By decoupling an artificial intelligence reasoning engine from direct database interactions, the system protects sensitive data endpoints. This separation allows for the updating or replacement of data sources without requiring a reconfiguration of the underlying machine learning models or system prompts, thereby increasing system maintainability. Furthermore, this intent-based routing facilitates a technical improvement in operational efficiency by activating only the relevant computational modules and data access paths for a given query, which reduces overall processing load and minimizes memory contention.

Additionally, the system overcomes the technical limitation of static user permissions by implementing a dynamic security perimeter by way of a security agent. Unlike traditional systems where access is determined solely at a login phase, the security agent can intercept retrieved data prior to user presentation to evaluate the requested data payload against a user identity profile and real-time security conditions. If a security condition is not satisfied, an intake agent and an integration agent programmatically bridge the gap to external enterprise workflows. This automated integration generates application programming interface calls to external systems, mitigating the manual administrative delays typical of legacy data governance processes.

### Example Data Management System

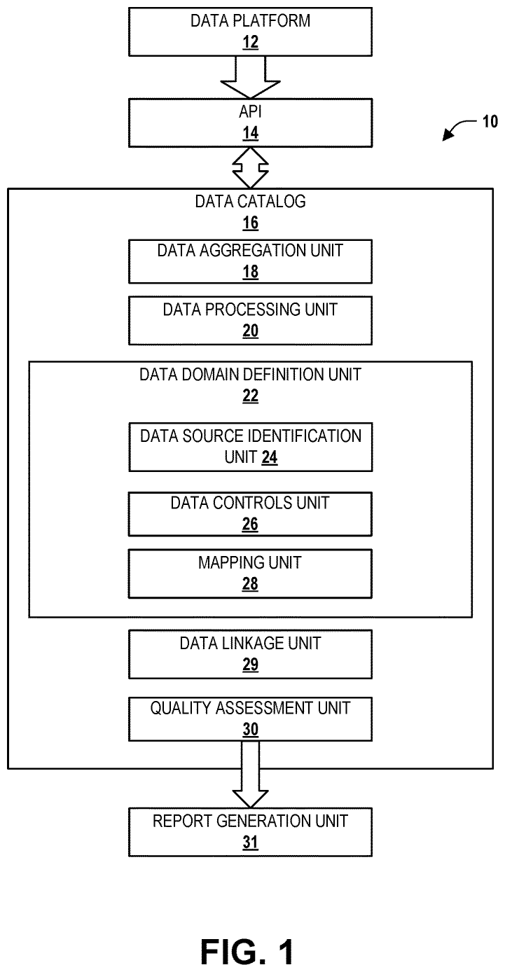

FIG. 1 is a conceptual diagram illustrating an example system configured to generate a data model comprising data sources, data use cases, and data governance policies retrieved from one or more of a plurality of data platforms via one or more of a plurality of platform and vendor agnostic application programming interfaces (APIs), in accordance with one or more techniques of this disclosure. In accordance with one embodiment, the example data management system integrates data from various enterprise sources to provide a comprehensive, authoritative, and up-to-date repository of information. Within the context of the subject disclosure, this data catalog system can serve as a deterministic map and establish data governance boundaries for the multi-agent natural language exploration architecture described later herein. By pre-defining data domains, access controls, and authoritative data lineage, the data management system provides the foundational structure that allows an orchestration agent to safely and accurately route natural language queries to appropriate specialized execution agents. While this framework optimizes the accuracy of the conversational data exploration, it is appreciated that such a comprehensive data management system is not a prerequisite for performing data exploration and natural language data insights disclosed herein.

In the example of FIG. 1, system 10 is configured to generate a data catalog 16. The data catalog 16 is configured to retrieve one or more data sources, one or more data use cases, and one or more data governance policies from one or more of a plurality of data platforms 12 by way of one or more of a plurality of platform and vendor agnostic APIs 14. Data catalog 16 further includes data aggregation unit 18. In some examples, data aggregation unit 18 collects, integrates, and consolidates data from one or more data platforms 12 through APIs 14 into a single, unified format or view. In some examples, data aggregation unit 18 retrieves data from data platforms 12 using various data extraction methods, such as SQL queries, web scraping, and file parsing.

Data catalog 16 may provide or act as part of a data management framework. The data management framework may implement an integrated capability to provide representative sample data and allow users to access needed data directly. The data management framework may enable users to navigate textually, visually (e.g., node to node), or both across a fully integrated data landscape. The data management framework may provide executive reporting on personal devices and applications executed on mobile devices. The data management framework may show data lineage in pictures, linear upstream/downstream dependencies, and provide the ability to see data lineage relationships. For example, the data management framework may aid in generating and rendering a horizontal stepwise data lineage.

In accordance with one embodiment, the data catalog 16 can maintain and document data lineage by acting as a centralized repository. The data management framework can consume the data lineage from the data catalog 16 and provide further processing. In one instance, the data management framework can ensure data lineage meets requirements by providing an audit trail for data usage and transformations.

Data catalog 16 may provide consistent data domains across data platforms. Users (e.g., administrators) may create consistent data domains across data platforms (e.g., Teradata and Apache Hadoop). Data catalog 16 may proactively establish data domains in a cloud platform, such as Google Cloud Platform (GCP) or cloud computing using Amazon Web Services, before data is moved to the cloud platform. Data catalog 16 may align data sets to data domains before the data sets are moved to the cloud platform. Data catalog 16 may further provide technical details on how to use the data domains in the cloud platform, aligned to the data domain concept implemented in data catalog 16.

Data catalog 16 may generate new business metadata attributes and descriptions. For example, data catalog 16 may exploit generative artificial intelligence capabilities to generate such business metadata attributes and descriptions. By automating the creation of these attributes, the data catalog 16 enriches the metadata repository, providing deeper semantic context for the multi-agent architecture to utilize when resolving complex natural language queries.

Data catalog 16 further includes data processing unit 20. In some examples, data processing unit 20 is configured to filter and sort data that has been aggregated by data aggregation unit 18. Data processing unit 20 may also clean, validate, normalize, and/or transform data such that it is consistent, accurate, and understandable. For example, data processing unit 20 may perform a quality check on the consolidated data by applying validation rules and data quality metrics to ensure that the data is accurate and complete. In some examples, data processing unit 20 may output the consolidated data in a format that can be easily consumed by other downstream systems, such as a data warehouse, a business intelligence tool, or a machine learning model. The data processing unit 20 may also be configured to maintain the data governance policies and procedures set forth by an enterprise for data lineage, data security, data privacy, and data audit trails. In some examples, data processing unit 20 is responsible for identifying and handling any errors that occur during the data collection, integration, and consolidation process. For example, data processing unit 20 may log errors, alert administrators, and/or implement error recovery procedures. Data processing unit 20 may also ensure optimal performance of the system by monitoring system resource usage and implementing performance optimization techniques such as data caching, indexing, and/or partitioning.

In some examples, existing data management sources, use cases, and controls may be integrated into data catalog 16 to prevent disruption of any existing processes. In some examples, ongoing maintenance for data management sources, use cases, and controls may be provided for data catalog 16. In some examples, data quality checks and approval mechanisms may be provided to ensure that data loaded into data catalog 16 is accurate. In some examples, data catalog 16 may utilize machine learning capabilities to rationalize data. In some examples, data catalog 16 may use a manual process to rationalize data. In some examples, data catalog 16 may implement a server-based portal for confirmation/approval workflows to confirm data.

Data catalog 16 further includes data domain definition unit 22 that includes data source identification unit 24, data controls unit 26, and mapping unit 28. Data source identification unit 24 may be configured to identify one or more data platforms 12 associated with data that has been aggregated by data aggregation unit 18 and processed by data processing unit 20. For example, data source identification unit 24 may identify a data platform or source associated with a portion of data by scanning for specific file types or by searching for specific keywords within a file or database. Data source identification unit 24 may identify the key characteristics and attributes of the data. Data source identification unit 24 may further be used to ensure data governance and compliance by identifying and classifying sensitive or confidential data. In some examples, data source identification unit 24 may be used to identify and remove duplicate data as well as to generate metadata about the identified data platforms or sources, such as the data's creator, creation date, and/or last modification date.

Data controls unit 26 may be configured to identify the specific security and privacy controls that are implemented to protect data. Data controls unit 26 may also be configured to determine the specific area or subject matter to which the controls are related. For example, if a data source contains sensitive personal information such as credit card numbers, social security numbers, or medical records, the data would be considered sensitive data and would be subject to compliance such as HIPAA, PCI-DSS, or GDPR. In some examples, data controls unit 26 may identify specific security controls such as access control, encryption, and data loss prevention that are required to protect the data from unauthorized access, disclosure, alteration, or destruction. Data controls unit 26 may generate metadata about the appropriate data controls, such as the data control type. In some examples, data controls unit 26 may further ensure that the data output by data processing unit 20 meets a certain quality threshold. For example, if the specific subject matter determined by data controls unit 26 is social security numbers, data controls unit 26 may check if any non-nine-digit numbers or duplicate numbers exist. Further processing or cleaning may be applied to the data responsive to data controls unit 26 determining that the data does not meet a certain quality threshold.

In some examples, all data sources are documented by data catalog 16, and all data quality controls are built around data source domains. In some examples, data controls unit 26 may determine that the right controls do not exist, which may result in an open control issue. For example, responsive to data controls unit 26 determining that the right controls do not exist, an action plan aligned to the control issue may be executed by a data use case owner to resolve the control issue. In some examples, data controls may be built around data use cases and/or data sources, in which the data use case owner may verify that the correct controls are in place. In some examples, the data use case owner is granted access to the data controls for the one or more data sources that are mapped to the data use case that is monitored and controlled by the data use case owner. Responsive to the data use case owner verifying the data controls for the one or more data sources, the computing system may receive data indicating that the data use case owner has verified the data controls. In some examples, a machine learning model may be implemented by data controls unit 26 to determine whether the correct controls exist, enough controls exist, and/or whether any controls are missing.

Mapping unit 28 may be configured to map data to a specific data domain based on information identified by data source identification unit 24 and data controls unit 26. For example, if data source identification unit 24 and data controls unit 26 determine that a portion of data is sourced from patient medical records and is assigned to compliance such as HIPAA, mapping unit 28 may determine the data domain to be healthcare. In some examples, mapping unit 28 may assign a code or identifier to the data that is then used to create automatic data linkages between data sources, data use cases, data governance policies, and data domains pertaining to the data. In some examples, mapping unit 28 may generate other data elements or attributes that are used to create data linkages. In some examples, mapping unit 28 is used to determine the data domain for each data source.

Taken together, data domain definition unit 22 may define a data domain specifying an area of knowledge or subject matter that a portion of data relates to. Once the data domain is defined by data domain definition unit 22, the data domain can be used to guide decisions for data governance, data management, and data security. The data domain may also be used to ensure that the data is used in compliance with requirements and to help identify any potential compliance issues related to the data within that data domain. Additionally, the data domain may help to identify any additional data controls that may be needed to protect the data. In some examples, the data domains may be pre-defined. For example, a business may define data domains that are aligned to the Wall Street reporting structure and the operating committee-level executive management structure prior to tying all metadata, use cases, and risk assessments to their respective data domains. In some examples, multiple data domains may exist, in which each domain includes identified data sources, written controls, mapped appropriate use cases, a list of use cases with associated controls/accountability, and a report that provides the status of the domain (e.g., how many and/or which use cases are using approved data sources).

In some examples, data domain definition unit 22 may also identify specific sub-domains within a larger data domain. For example, within a finance domain, there may be sub-domains such as investments, banking, and accounting. For example, within a healthcare domain, there may be sub-domains such as cardiovascular health, mental health, and pediatrics.

Information assets, also referred to herein as data assets, may be aligned to one or more data domains and sub-domains to simplify implementation of domain-specific data management policy requirements, referential industry common banking architectures, data products, data distribution, use of the data, entitlements, and cost reduction. Data domain definition unit 22 may create domains and sub-domains in accordance with enterprise-established guidelines. Data domain definition unit 22 may assign data sources and data use cases to domain, sub-domain, and data products, with business justification and approval. Data domain definition unit 22 may align technical metadata and business metadata with data sources or data use cases, agnostic to data platform. Data domain definition unit 22 may communicate domain, sub-domain, data products, and associations to data platforms via vendor- and platform-agnostic APIs, such as API 14. Data domain definition unit 22 may automatically create a data mesh to implement BPPA and data products using API 14 on data platforms, regardless of whether the platform is on premises, private cloud, hybrid cloud, or public cloud.

Data domain definition unit 22 may define data domains, sub-domains, and data products in accordance with enterprise-established guidelines. Data source identification unit 24 and mapping unit 28 may align information assets to the defined data domains, sub-domains, and data products. Data controls unit 26 may define controls for the information assets and alignment. Data domain definition unit 22 may leverage API 14 to communicate with data platform 12 to automatically create a data mesh, controls, and entitlements.

Data catalog 16 further includes data linkage unit 29 that may be configured to create a data linkage between one of the data sources, one of the data use cases, one of the data governance policies, and one of the data domains. Data catalog 16 may unify multiple components together, i.e., data catalog 16 may establish linkages between various components that used to be scattered. More specifically, data linkage unit 29 may connect data from various sources by identifying relationships between data sets or elements. In some examples, data linkage unit 29 may identify relationships between data sources, data use cases, data governance policies, and data domains based on identifying information included in the data or metadata. For example, data source identification unit 24 may identify the key attributes of the data and data controls unit 26 may identify the correct data controls based on the key attributes of the data. Mapping unit 28 may then be used to generate data attributes or elements that indicate a specific data domain based on the information identified by data source identification unit 24 and data controls unit 26. Data linkage unit 29 may then automatically create data linkages between data sources, data use cases, data governance policies, and data domains based on the data domain that mapping unit 28 has aligned the data to. In some examples, data linkage unit 29 may improve data quality by also identifying and rectifying errors or inconsistencies in the data that prevent linkages from being created.

By creating these automatic data linkages, data catalog 16 may provide a more efficient and organized means of ingesting large amounts of data. For example, 5000 data sources belonging to 7 different domains may be ingested into data catalog 16, in which the linkages between all the data sources and all the data domains are created automatically by data linkage unit 29. Further, the automatic data linkages created by data linkage unit 29 may provide a more comprehensive understanding of the data and its context. For example, linking data from various sources, such as customer purchase history, customer demographic data, and customer online activity, can provide a deeper understanding of customer behavior and preferences.

In some examples, the data linkages created by data linkage unit 29 are enforced by platform and vendor agnostic APIs 14. For example, a single API may be constructed for each data domain that has built-in hooks for direct connection into a repository of data sources associated with a particular data domain. In some examples, the APIs may be designed to enable the exchanging of data in a standardized format. For example, the APIs may support REST (Representational State Transfer), which is a widely used architectural style for building APIs that use HTTP (Hypertext Transfer Protocol) to exchange data between applications. REST APIs enable data to be exchanged in a standardized format, which may then enable data linkages to be created more easily and efficiently. In some examples, some data linkages may need to be manually created by a data use case owner who monitors and controls the data use case and/or by the data domain executive who monitors and controls the data domain.

Data catalog 16 further includes quality assessment unit 30 that may be configured to determine, based on the data governance policy and quality criteria set forth by the data use case owner and the data domain executive, the level of quality of the data source. In some examples, a machine learning model may be implemented by quality assessment unit 30 to determine a numerical score for each data source that indicates the level of quality of the data source. In some examples, data sources may also be sorted into risk tiers by quality assessment 30, wherein certain risk tiers indicate that a data source is approved and/or usable, which may be based on the numerical score exceeding a required threshold set forth by the data use case owner and/or the data domain executive. In some examples, the data use case owner and/or the data domain executive may be required to manually fix any data source that receives a numerical score less than the required threshold.

Data catalog 16 may output data relating to a data source to report generation unit 31. In some examples, report generation unit 31 may generate, based on the level of quality of the data source, a report indicating the status of the data domain and data use case. For example, in the case of a mortgage, a form (i.e., a source document) may be submitted to a loan officer. All data flows may start from the source document, wherein the source document is first entered into an origination system and later moved into an aggregation system (in which customer data may be brought in and aggregated with the source document). A report may need to be provided that states whether discrimination occurred during the flow of data. Well-defined criteria may need to be used to determine whether discrimination occurred, such as criteria for data quality (based on, for example, entry mistakes, data translation mistakes, data loss, ambiguous data, negative interest rates). Further, publishing and marketing of data may have different data quality criteria. As such, data controls may need to be implemented to ensure proper data use. In this example, report generation unit 31 may generate a report indicating the status of the mortgage domain, the publishing use case, and the marketing use case based on the quality of the source document.

Data catalog 16 may build data insights, reporting, scorecards, and metrics for transparency on the status of data assets and corrective actions to provide executive-level accountability for data quality, data risks, data controls, and data issues. In some examples, data catalog 16 may include a domain “scoreboard” or dashboard that provides an on-demand report of data stored within data catalog 16. For example, the domain dashboard may show each data source with its associated policy designation, domain, sub-domain, and app business owner. Data catalog 16 may further classify each data use case, data source, and data control. The domain dashboard may further define and inventory data domains.

In this way, data catalog 16 may provide users and/or businesses an insightful and organized view of data that may aid in making decisions. Additionally, the reporting capabilities of data catalog 16 may aid in simplifying data flows, as the insights provided by data catalog 16 may identify which data sources are of low quality or have little value added to a certain process.

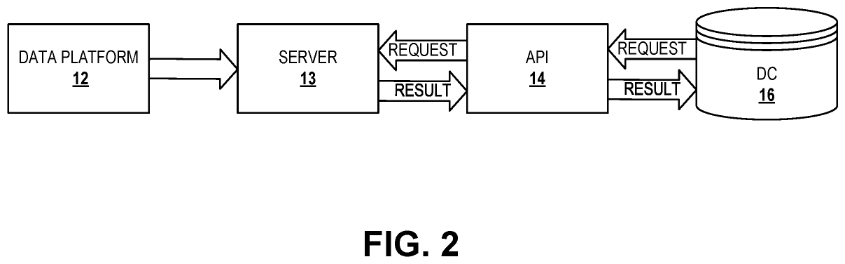

FIG. 2 is a block diagram illustrating an example system including vendor and platform agnostic APIs configured to ingest data, in accordance with one or more techniques of this disclosure. One API may exist per data domain or subject matter (e.g., the same API may be used for a bulk upload or manual entry of data). In the example of FIG. 2, data catalog 16 establishes a connection to data platform 12 via platform and vendor agnostic APIs 14 and server 13. APIs 14, in accordance with the techniques described herein, may be APIs that are not tied to a specific platform or vendor, i.e., APIs 14 may be designed to function across multiple different platforms and technologies, regardless of the vendor used. For example, APIs 14 may be designed to function across different types of hardware and software platforms, such as Windows®, Linux®, or MacOS®, or any other type of platform that supports the API. APIs 14 may further be designed to function across different vendors' products, i.e., APIs 14 are not specific to a particular vendor and can be used to connect to different products from different vendors. Thus, APIs 14 may provide a consistent and standardized way of accessing data across different data platforms 12, regardless of the vendor or technology used. APIs 14 may be used to bring all data into a rationalized and structured data model to link data sources, application owners, and domain executives. APIs 14 may allow data catalog 16 to connect to different data platforms 12 which may be, but are not limited to, databases, data warehouses, data lakes, and cloud storage systems, in a consistent and uniform manner. APIs 14 may collect metadata, data use cases, and/or data governance policies or procedures and assessment outcomes from data platforms 12. Data platforms 12 may be any reporting, analytical, modeling, or risk platforms.

In the example of FIG. 2, a request may be sent by a client, such as a user or an application of data catalog 16, to server 13. The request may be a simple query, a command to retrieve data, or a request for access to a specific data platform 12. API 14 may receive the request from data catalog 16 first before translating the request and sending it to server 13. Upon receiving the request from API 14, server 13 may process the request and may access data platform 12 to retrieve the requested data. Server 13 may then send data back to the API 14, which may format the data into a standardized format that data catalog 16 can understand or ingest. API 14 may then send the data to data catalog 16, wherein data catalog 16 may then store the received data.

APIs 14 may be further configured to support authentication and authorization procedures, which may help ensure that data is accessed and used in accordance with governance policies. For example, APIs 14 may define and enforce rules for data access and usage that ensure authorized users are able to access certain data and that all data is stored and processed in compliance with requirements.

In some examples, a data management framework (DMF) may be implemented to perform automatic metadata harvesting while utilizing the same API. In some examples, external tools may be used to pull in data. In some examples, data catalog 16 may include different data domains with pre-established links that are enforced via APIs 14. For example, a technical metadata API may create an automatic data linkage for all technical metadata pertaining to the same data domain. The data management framework may further automate the collection of metadata, data use cases, and risk assessment outcomes into data catalog 16. The data management framework may also automate a user interface to maintain and provide updates on the contents of data catalog 16. The data management framework may also provide a feature to automatically manage data domains defined in accordance with enterprise-established guidelines (e.g., the Wall Street reporting structure and the operating committee-level executive management structure). The data management framework may also automate approval workflows that align the contents of data catalog 16 to the different data domains. The data management framework may be applied to G-SIB banks but may also be applied to any controlled industry (e.g., Financial Services, Healthcare, etc.).

Implementing data management and governance may use metadata for information assets and a lineage of the information assets. Lines of business may build their own metadata and lineage via APIs, such as API 14 as shown in FIG. 2. Such APIs may enable data platforms, authorized business users, and technology users to send new or changed technical metadata automatically or manually in data catalog (DC) 16. API 14 may be a platform- and/or vendor-agnostic API. API 14 may enable data platforms, authorized business users, and technology users to send new and changed lineage data automatically or manually to DC 16. API 14 may further enable data platforms, authorized business users, and technology users to send new and changed business metadata automatically or manually to DC 16.

Data platforms, such as data platform 12, authorized business users, and technology users may invoke API 14 to send new and changed metadata and lineage data to DC 16. API 14 may perform requestor authorization, validation, and/or desired processing, and may communicate back with requestor success or failure messages appropriately.

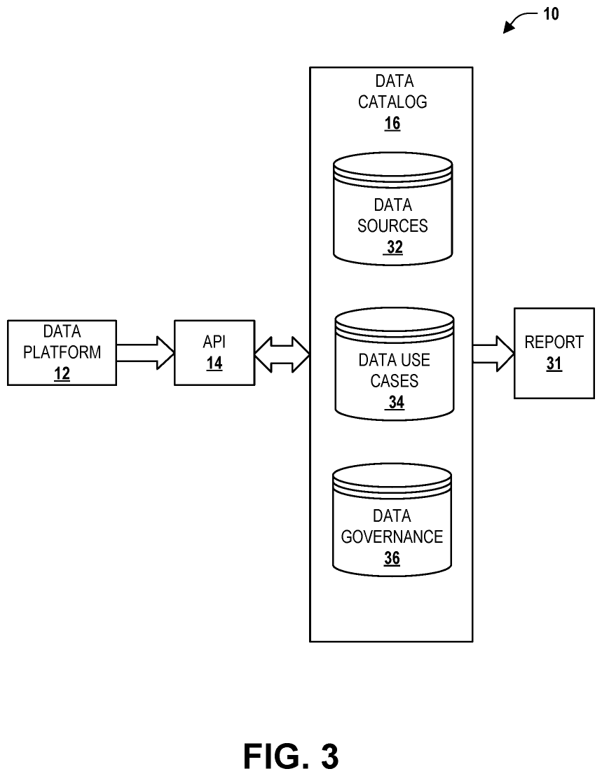

FIG. 3 is a conceptual diagram illustrating another view of example system 10 configured to generate, based on the level of quality of a data source, a report indicating the status of the data domain and data use case, in accordance with one or more techniques of this disclosure. In the example of FIG. 3, data catalog 16 includes data sources storage unit 32, data use cases storage unit 34, and data governance storage unit 36. System 10 of FIG. 1 may operate substantially similar to system 10 of FIG. 3, and both may include the same components. Data sources storage unit 32 may be configured to store and manage data sources within data catalog 16. Data sources storage unit 32 may serve as a central repository for data sources that are retrieved from data platforms 12 via APIs 14, allowing users to discover, understand, and access data from data platforms 12 without needing to know the specific technical details of each platform. Data sources storage unit 32 may be configured to store data sources in a variety of formats, such as structured, semi-structured, and unstructured data. Data sources storage unit 32 may also store data sources in different storage systems, such as relational databases, data lakes, or cloud storage. Data sources storage unit 32 may be configured to handle large amounts of data while meeting scalability and performance requirements. Data sources storage unit 32 may also provide a secure and controlled access to data sources by implementing access control mechanisms such as role-based access control, data masking, and encryption to protect the data from unauthorized access, disclosure, alteration, or destruction. Additionally, data sources storage unit 32 may provide a way to version the data sources, and track changes to the data over time. Data sources storage unit 32 may also support data lineage, or provide information about where the data came from, how it was processed, and how it was used.

In some examples, technical metadata may be pulled into data catalog 16 from a data store via APIs 14. The technical metadata may undergo data aggregation, data processing, data controls identification, data mapping, and data domain alignment as described with respect to FIG. 1. The technical metadata may include a group of data attributes, such as the relationship with the data store. The technical metadata may also be stored in data sources storage unit 32. In another example, business metadata may also be pulled into data catalog 16 via APIs 14. The business metadata may define business data elements for physical data elements in the technical metadata. In other words, the business metadata may provide context about the data in terms of its meaning, usage, and relevance to the business while the technical metadata describes the physical data elements or technical aspects of the data, such as its format, type, lineage, and quality. The business metadata may also undergo data aggregation, data processing, data controls identification, data mapping, and data domain alignment as described with respect to FIG. 1. As such, data catalog 16 may consolidate and link business metadata utilized by business analysts and data scientists with technical metadata utilized by database administrators, data architects, or other IT professionals upon determining that the technical metadata and business metadata are aligned to the same data domain.

In some examples, upon sending a request to APIs 14 to pull in business metadata, an additional operation may be performed to check if a linked physical data element already exists. In some examples, upon sending a request to APIs 14 to pull in a physical data element, an additional operation may be performed to check if a dataset and data store already exists. In some examples, if a data linkage is not identified, an error message may be generated. In some examples, if certain metadata cannot be loaded, a flag may be set to reject the entire file containing the metadata.

Data use cases storage unit 34 of data catalog 16 may be configured to store data containing information pertaining to various data use cases within an organization. In some examples, data use cases storage unit 34 stores data including use case identification information (e.g., the name, description, and type of the use case). As such, data use cases storage unit 34 may allow for easy discovery, management, and governance of data use cases by providing a unified view of all relevant information pertaining to data usage. The data use case data may undergo data aggregation, data processing, data controls identification, data mapping, and data domain alignment as described with respect to FIG. 1. In some examples, users of data catalog 16 may search for specific use cases by name or browse by specific categories. In some examples, users of data catalog 16 may also submit new use cases for review and approval by data use case owners and/or domain executives.

Data governance storage unit 36 of data catalog 16 may be configured to store data containing information pertaining to the management and oversight of data within an organization. In some examples, data governance storage unit 36 may store data including information indicating data ownership, data lineage, data quality, data security, data policies, and assessed risk. Data governance storage unit 36 may allow for easy management and enforcement of data governance policies by providing a unified view of all relevant information pertaining to data governance. The data governance data may undergo data aggregation, data processing, data controls identification, data mapping, and data domain alignment as described with respect to FIG. 1. In some examples, a user of data catalog 16 may submit new governance policies for review and approval by data use case owners and/or data domain executives. Additionally, data governance storage unit 36 may be configured to monitor compliance with governance policies within data catalog 16 and identify any potential violations. Data governance storage unit 36 may also store information relating to compliance and governance activities and provide an auditable trail of all changes made to any policies within data catalog 16.

Taken together, data catalog 16 may output information relating to a data source or platform to report generation unit 31 that is based on the data linkage created between the data source or platform and the data use cases, data governance policies, and data domains by unified data platform 16. For example, with respect to FIGS. 1 and 2, upon a portion of data being retrieved from data platform 12 via API 14, the portion of data may undergo data aggregation, data processing, data controls identification, data mapping, and data domain alignment. The portion of data may then undergo a data linkage in which the data is linked to other portions of data that are aligned to the same data domain and/or data use cases and data governance policies that are aligned to the same data domain. Each step may be performed in accordance with the information stored in data sources storage unit 32, data use cases storage unit 34, and data governance storage unit 36. The portion of data may further undergo a quality assessment. Upon determining the level of quality of the portion of data based on the information stored in data sources storage unit 32, data use cases storage unit 34, and data governance storage unit 36, report generation unit 31 may generate a report indicating the status of the data domain aligned to the portion of data and the data use case linked to the portion of data. The report may also indicate the quality and credibility of the data source or platform from which the portion of data was retrieved. As such, users of data catalog 16 may gain a better understanding of relationships between the data and which data are lacking in value, which may aid in gaining better understanding of the state of the data and better business insights.

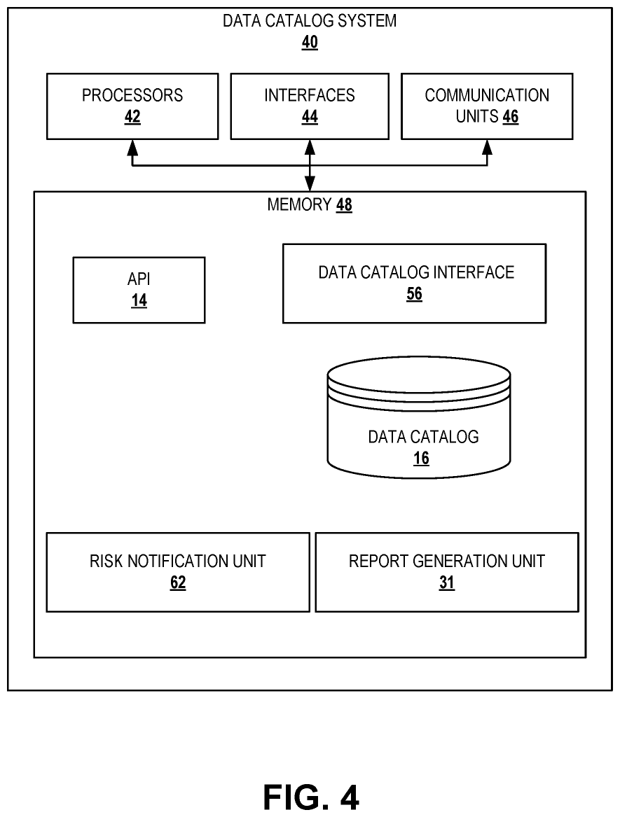

FIG. 4 is a block diagram illustrating an example system configured to manage a data catalog, in accordance with one or more techniques of this disclosure. In the example of FIG. 4, data catalog system 40 includes one or more processors 42, one or more interfaces 44, one or more communication units 46, and one or more memory units 48. Data catalog system 40 further includes API unit 14, data catalog interface unit 56, data catalog storage unit 16, risk notification unit 62, and report generation unit 31, each of which may be implemented as program instructions and/or data stored in memory 48 and executable by processors 42 or implemented as one or more hardware units or devices of data catalog system 40. Memory 48 of data catalog system 40 may also store an operating system (not shown) executable by processors 42 to control the operation of components of data catalog system 40. Although not shown in FIG. 4, the components, units, or modules of data catalog system 40 are coupled (physically, communicatively, and/or operatively) using communication channels for inter-component communications. In some examples, the communication channels may include a system bus, a network connection, an inter-process communication data structure, or any other method for communicating data.

Processors 42, in one example, may comprise one or more processors that are configured to implement functionality and/or process instructions for execution within data catalog system 40. For example, processors 42 may be capable of processing instructions stored by memory 48. Processors 42 may include, for example, microprocessors, digital signal processors (DSPs), application specific integrated circuits (ASICs), field-programmable gate arrays (FPGAs), or equivalent discrete or integrated logic circuitry, or a combination of any of the foregoing devices or circuitry.

Memory 48 may be configured to store information within data catalog system 40 during operation. Memory 48 may include a computer-readable storage medium or computer-readable storage device. In some examples, memory 48 includes one or more of a short-term memory or a long-term memory. Memory 48 may include, for example, random access memories (RAM), dynamic random access memories (DRAM), static random access memories (SRAM), magnetic discs, optical discs, flash memories, or forms of electrically programmable memories (EPROM) or electrically erasable and programmable memories (EEPROM). In some examples, memory 48 is used to store program instructions for execution by processors 42. Memory 48 may be used by software or applications running on data catalog system 40 to temporarily store information during program execution.

Data catalog system 40 may utilize communication units 46 to communicate with external devices via one or more networks. Communication units 46 may be network interfaces, such as Ethernet interfaces, optical transceivers, radio frequency (RF) transceivers, or any other type of devices that can send and receive information. Other examples of such network interfaces may include Wi-Fi, Near Field Communication (NFC), or Bluetooth® radios. In some examples, data catalog system 40 utilizes communication unit 46 to communicate with external data stores via one or more networks.

Data catalog system 40 may utilize interfaces 44 to communicate with external systems or user computing devices via one or more networks. The communication may be wired, wireless, or any combination thereof. Interfaces 44 may be network interfaces (such as Ethernet interfaces, optical transceivers, radio frequency (RF) transceivers, Wi-Fi or Bluetooth radios, or the like), telephony interfaces, or any other type of devices that can send and receive information. Interfaces 44 may also be output by data catalog system 40 and displayed on user computing devices. More specifically, interfaces 44 may be generated by data catalog interface 56 of data catalog system 40 and displayed on user computing devices. Interfaces 44 may include, for example, a graphical user interface (GUI) that allows users to access and interact with data catalog system 40, wherein interacting with data catalog system 40 may include actions such as requesting data, searching data, storing data, transforming data, analyzing data, visualizing data, and collaborating with other user computing devices.

Risk notification unit 62 may generate alerts or messages to administrators upon the detection of any risks within data catalog system 40. For example, upon data processing unit 20 logging a particular error, risk notification unit 62 may send a message to alert administrators of data catalog system 40. In another example, upon certain metadata not being able to be loaded into data catalog system 40, risk notification unit 62 may generate a message to administrators that indicates the entire file containing the metadata should be rejected.

Data catalog system 40 of FIG. 4 may provide a dot cloud representation of data catalog 16. The dot cloud may allow executives and decision makers to make better business decisions more easily within their scope (e.g., domain, sub-domain, or the like). Processors 42 may collect various data via interfaces 44, where the data may include, for example, costs, defects, efficiency, or the like. Processors 42 may integrate those various sets of data and present the data via interfaces 44 in a configurable manner. For example, processors 42 may render visual and/or textual representations of the data to allow users to interrogate or work with the data.

Processors 42 may collect additional needed data via interfaces 44. Processors 42 may communicate the additional data to data catalog 16 via API 14 to allow for interrogation and storage with existing data (e.g., existing information assets). Processors 42 may then present a representation of the data via interfaces 44 to a user. Processors 42 may also present multiple configuration options to allow the user to request a display of the information via interfaces 44 in a manner that is best suited to the user's needs.

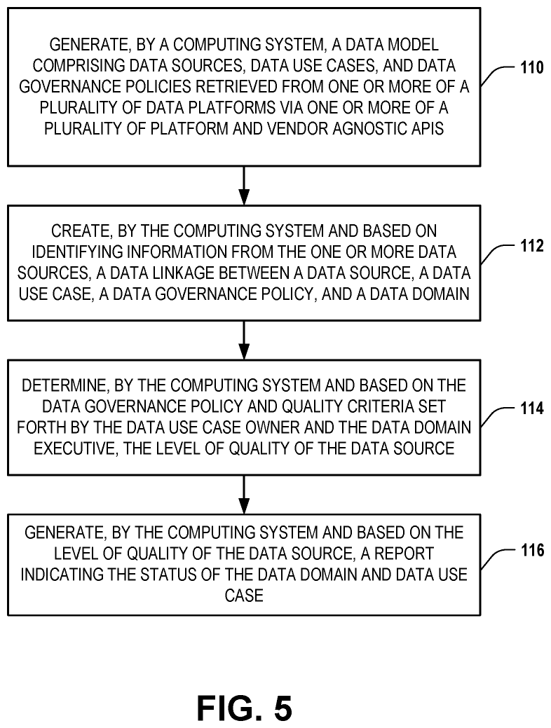

FIG. 5 is a flowchart illustrating an example process by which a computing system may evaluate data quality to generate a status report, including generating a data model comprising data sources, data use cases, and data governance policies retrieved from one or more of a plurality of data platforms via one or more of a plurality of platform and vendor agnostic APIs, in accordance with one or more techniques of this disclosure. The technique of FIG. 5 may first include generating, by a computing system, a data model comprising data sources, data use cases, and data governance policies retrieved from one or more of a plurality of data platforms via one or more of a plurality of platform and vendor agnostic APIs (110). The data sources, data use cases, data governance policies, and APIs are aligned to one or more of a plurality of data domains. One vendor and platform agnostic API may exist for each data domain or subject area of the data model. The technique further includes creating, by the computing system and based on identifying information from the one or more data sources, a data linkage between a data source, a data use case, a data governance policy, and a data domain (112). The data linkage is enforced by the platform and vendor agnostic API. The data use case is monitored and controlled by a data use case owner and the data domain is monitored and controlled by a data domain executive. The technique further includes determining, by the computing system and based on the data governance policy and quality criteria set forth by the data use case owner and the data domain executive, the level of quality of the data source (114). The technique further includes generating, by the computing system and based on the level of quality of the data source, a report indicating the status of the data domain and data use case (116).

### Example Data Organization and Distribution System

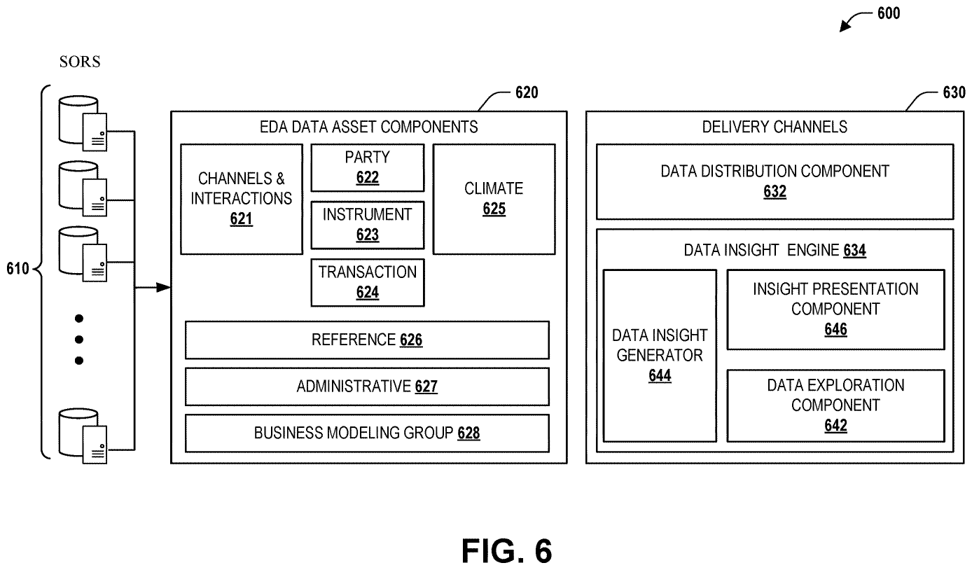

FIG. 6 illustrates an example data organization and distribution system 600. System 600 includes data storage systems 610 (also referred to as “systems of record (SORS)”), enterprise data architecture (EDA) data asset components 620, and delivery channels 630. The data storage systems 610 can serve as source data for the EDA data asset components 620, which can organize source data for subsequent delivery through delivery channels 630, such as dashboards, APIs, or artificial intelligence tools.

Data storage systems comprise data storage systems_{1-X} (collectively referred to as “data storage systems 610” and individually as “data storage system 610”). Data storage systems 610 can correspond to systems of record, which refers to an authoritative repository for a particular set of data. Examples include a customer relationship management (CRM) system for customer data and enterprise resource planning (ERP) systems for financial transactions, among others. The systems of record can align with data governance as noted above. In this manner, an appropriate authoritative system of record can be accessed for computations. The storage systems 610 can capture repositories of raw, original data that serve as the source that is input into the EDA data asset components 610.

EDA data asset components 620 categorize and organize source data from the data storage systems 610 into logical groupings, such as channels and interactions 621, party 622, instrument 623, transaction 624, climate 625, reference 626, administrative 627, and business modeling group (BMG) 628. Channels and interactions 621 can correspond to data that is related to communication pathways, such as customer engagement, channels of interactions, and touchpoints. Party 622 refers to entities involved in a transaction or relationship, such as customers or clients. Instrument 623 refers to a mechanism that facilitates transactions such as financial tools or contracts. Transaction 624 involves records of activities or operations between parties, such as purchases. Climate 625 refers to environmental factors, sustainability metrics, or related external conditions that influence operations. Reference 626 can correspond to standardized codes, categories, or identifiers. Administrative 627 can be data that supports operation, internal processes, or governance. Business modeling group 628 can pertain to data sets and models that support planning, analysis, or simulations.

EDA data asset components 620 can work together with a DMF and DC to ensure data management, accessibility, and utility. The EDA data asset components 620 can establish the structure of data from data storage systems. The DMF can process the data and enforce governance, quality, and transformation rules as data moves through a pipeline. The DC can organize and catalog data assets to ensure discoverability and useability.

In one instance, data asset components 620 can create a baseline structure coupling data from across multiple systems of record, which serve as the basis of data being queried. The basis of data can enforce governance and quality. However, this need not be the case. In one scenario, that data can be checked to ensure the data is authoritative and approved for use. The DMF can be utilized to identify systems of record that are authoritative and approved for use.

Delivery channels 630 provide accessibility mechanisms for data insights and exploration. Delivery channels 630 include data distribution component 632 and data insight engine 634.

Data distribution component 632 can eliminate complexities of data distribution and provides a unified way for applications and users to interact with distributed data sets from the data storage systems 610. In accordance with one embodiment, data distribution component 632 enables sharing of data through application programming interfaces (APIs). APIs provide a set of rules or protocols that enable systems, applications, or users to access and retrieve data.

Data insight engine 634 is operable to simplify and democratize data access and analysis. Further, data insight engine 634 can streamline the process of deriving actionable insights from organizational data. The data insights engine 634 comprises data exploration component 642, data insight generator 644, and insight presentation component 646.

Data exploration component 642 is operable to employ one or more machine learning models to allow users to explore data interactively and enable extraction of meaningful insights through natural language queries. In other words, the data exploration component 642 empowers users to uncover patterns, relationships, and insights from raw data sets intuitively and efficiently. The data exploration component 642 can receive natural language queries to explore data provided by the data storage systems 610. In accordance with some embodiments, the data exploration component 642 can perform natural language processing and invoke a machine learning model to generate data queries in a data query language. For example, a SQL query can be generated to retrieve data responsive to the natural language query. The data query can be submitted for processing and data returned that satisfies the data query. A response to the natural language query can then be generated that integrates the obtained data in some manner. In accordance with one aspect, the data exploration component 642 can be embodied as a data generative pre-trained transformer. In a sense, the data exploration component 642 supports asking questions of data.

Data insight generator 644 can provide automated findings that can be analyzed further through the data exploration component 642. More specifically, the data insight generator 644 can analyze data from one or more sources (e.g., data storage systems 610) and provide actionable insights. The actionable insights can include summarized information and contextual recommendations. The data insight generator 644 can also perform predictive analytics such as forecasts and risk predictions as well as anomaly detections such as unusual patterns or deviations from benchmarks. By way of example and not limitation, the data insight component 644 can be configured to generate interesting dimensions and insights, such as customer trends and economic indicators, among others.

In accordance with one embodiment, the data insight generator 644 can be configured to extract and organize data in a meaningful way to return one or more plausible answers to a question. In other words, the data insight generator can extract actionable insight from data. Consider an example in which a user asks for a list of customers who may be interested in mortgages. The data insight generator 644 can locate all customers and look at their interactions to determine which customers are inquiring about or clicking on housing or mortgage-related data. More specifically, the data insight generator 644 may identify customers who do not have a mortgage and who have recently subscribed to housing-related websites (e.g., real estate and housing marketplaces, home value estimators, etc.). A propensity score can then be generated for customers to capture the likelihood that a customer would be interested in mortgages. The propensity score can be utilized to answer the question and provide a list of customers who may be interested in mortgages. However, the propensity score itself corresponds to an insight that can be stored for use. In this manner, data insight generator 644 separates generating an answer on the fly based on the data versus pre-generate and store an answer that can help build upon the data set or be utilized on its own.

While described in the context of mortgages, data insight generator 644 is configured to generate propensity scores for a variety of enterprise data domains by executing a generalized scoring algorithm. The scoring algorithm first identifies a target event within a target data source 610, such as a product inquiry, a service subscription, or a specific user interaction pattern. Data insight generator 644 then extracts a set of feature vectors from the user identity profile and historical interaction logs stored in the data storage systems 610. These feature vectors are processed through a predictive model to determine a weighted correlation between the user's historical behavior and the target event. The data insight generator 644 outputs the propensity score as a numerical value representing the probability of the user engaging with the target event. To calculate this probability, data insight generator 644 may utilize a weighted correlation formula, such as P=Σ(wᵢ×fᵢ), where P represents the final propensity score, wᵢ represents the assigned weight of a specific historical interaction, and fᵢ represents the frequency or recency of that interaction feature vector. By applying this or a similar logistic regression equation, data insight generator 644 normalizes the diverse interaction data from the data storage systems 610 into a standardized probability scale (e.g., bounded between 0.0 and 1.0). This generalized scoring framework allows the system to derive actionable insights across disparate datasets, including a structured data repository and metadata repository without being limited to a specific business vertical.

The insight presentation component 646 is operable to deliver insights in an accessible, understandable, and actionable format. The insight presentation component 646 can support diverse formats, such as visualizations (e.g., charts, graphs, heatmaps, dashboards), text summaries (e.g., natural language processing summaries), and interactive components (e.g., filters, drill down, dynamic visualizations).

In accordance with one aspect, data anonymization masking can be employed to reduce the risk of exposing sensitive customer information. For example, the data insight engine 634 or other systems or components can identify sensitive customer data and replace the data with fabricated data. In this manner, insights can be generated, and data can be explored while at least mitigating the risk of exposing sensitive customer data.

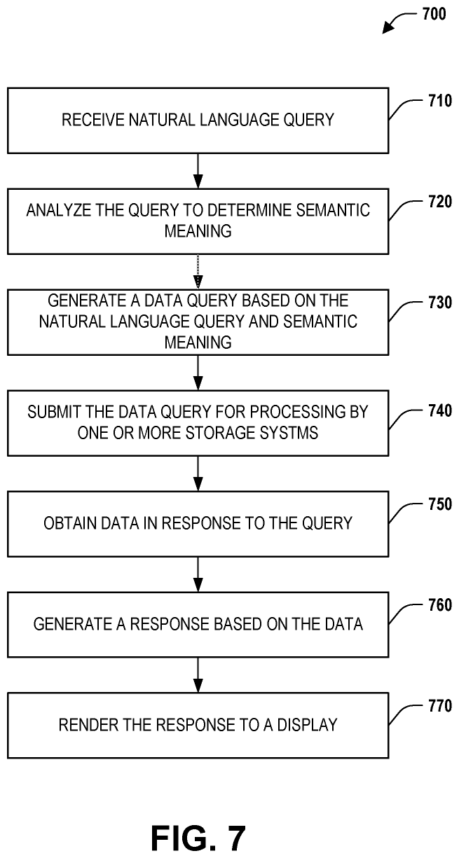

FIG. 7 is a flow chart diagram depicting an example method 700 of data exploration. In one aspect, method 700 can be implemented by the data insight engine 634 of FIG. 6, and more particularly data exploration component 642.

Method 700 starts at block 710 with receiving a natural language query. In one instance, the natural language query can be text-based or converted into a text-based query. As an example, the query could be, “How many auto loans does ABC Bank have in North Carolina?”

Method 700 continues to block 720 with analyzing the query to determine semantic meaning. For example, natural language processing techniques can be employed to parse the query and determine query intent and particular entities involved. In the example query above, the query intent is clear, namely retrieving the number of auto loans for a bank in North Carolina. The entities can be auto loans, a bank, and North Carolina.

Method 700 proceeds to block 730 with generating a data query based on the natural language query and the semantic meaning. For instance, a data query can be specified in a data query language (e.g., SQL) to retrieve the number of auto loans ABC Bank has in North Carolina. Suppose a table of loans exists. A query can be generated such as:

```
SELECT COUNT (*) As total_auto_loans
FROM loans
WHERE loan_type = “Auto”
  AND state = “North Carolina”
  AND bank_name = “ABC Bank”
```

In accordance with one aspect, a Text-to-SQL machine learning model can be invoked to generate such a query from a natural language query to retrieve the number of auto loans in North Carolina. It is to be appreciated from the sample data query that the natural language query is much more intuitive and does not require technical knowledge regarding a particular query language.

Method 700 continues to block 740 with submitting the generated data query for processing by one or more relevant data storage systems.

Method 700 continues at block 750 with obtaining data in response to the data query submitted. For example, the number of auto loans could be 100,000.

Method 700 proceeds to block 760 with generating a response based on the data. In accordance with one aspect, solely the data can be returned, such as “100,000.” Alternatively, a text-based response can be generated that incorporates the obtained data, such as “ABC bank has 100,000 auto loans in North Carolina.” In another instance, a visual graph can be generated for display alone or in conjunction with a text-based response. For example, one or more visualization tools or libraries can be invoked to generate results in a user-friendly graphical format, such as a bar chart, line chart, heat map, or scatter plot.

Method 700 continues to block 770 with rendering the response to a display. In one instance, the response can be presented in a dashboard. Alternatively, the response can be rendered in a report.

To facilitate clarity and understanding with respect to method 700 a simple query is discussed. Of course, natural language queries can be much more expressive and complicated. For example, a natural language query may be “What is the relationship between outstanding auto loan balances among affluent and non-affluent customers using credit limits for customers in Charlotte, North Carolina.”

Method 700 provides individuals with an intuitive mechanism to derive insights without requiring a technical background or specialized analytical tools by exploiting natural language queries as a primary interface. The approach reduces time spent on manually generating data enabling individuals to focus more on data analysis and interpretation. Method 700 streamlines and optimizes access to data, mitigating inefficiencies associated with repetitive ad-hoc requests, which may overlook significant information. By facilitating expeditious and efficient identification, utilization, and analysis of data, method 700 enables individuals to enhance organizational processes and deliverables.

Note that FIG. 7 is just one example of a method, and other methods including fewer, additional, or alternative operations are possible consistent with this disclosure.

Aspects of this disclosure pertain to democratizing access and interaction with data across numerous data sources to discover actionable intelligence. Accordingly, the users could be anyone with access to the data. Aspects can be particularly useful to several categories of people including executives, data analysts, compliance teams, product development, and research teams, as well as external auditors or regulators.

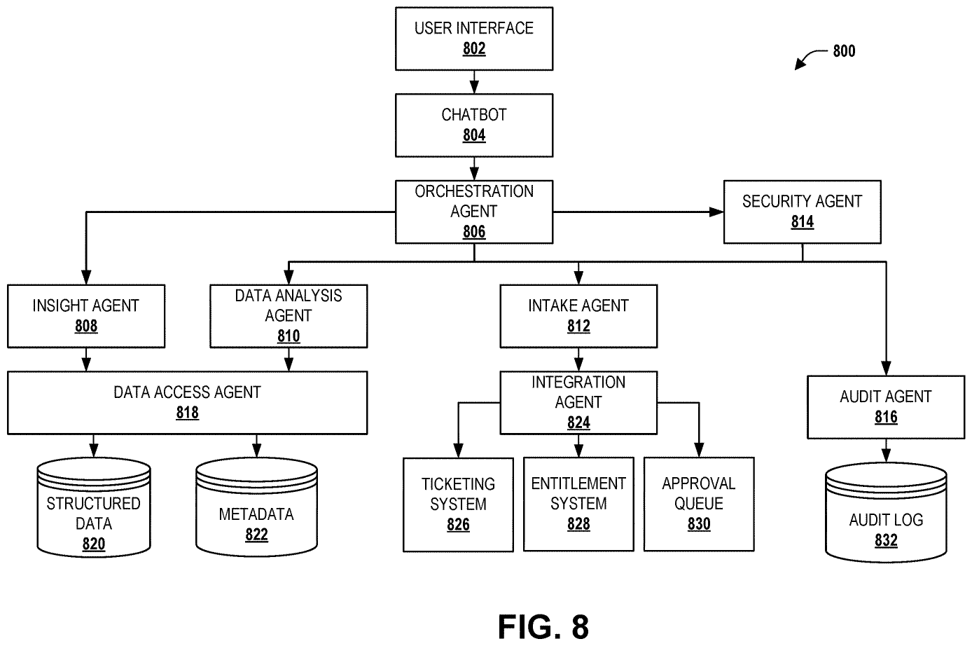

FIG. 8 illustrates an example multi-agent system architecture 800 configured to evaluate natural language queries and route the natural language queries to specialized execution agents. In accordance with one aspect, multi-agent system architecture 800 represents an implementation of the data insight engine previously described in connection with FIG. 6. By incorporating the multi-agent architecture into the broader system, the computing environment dynamically routes requests and enforces strict data governance protocols.

User interface 802 comprises a graphical display configured to obtain user inputs and present system outputs. The user inputs include keystrokes, voice commands, or other interactions forming a raw natural language query. User interface 802 outputs the raw natural language query to a conversational module.

Chatbot 804 operates as the primary conversational interface module and executes frontend technologies comprising browser frameworks, charting libraries, and markdown renderers. Chatbot 804 receives the raw natural language query from user interface 802. To maintain conversational context, chatbot 804 stores prior user prompts and prior system responses within a conversational memory buffer. Chatbot 804 appends the raw natural language query to the conversational memory buffer and formats the combined data into a structured request payload. Chatbot 804 then transmits the structured request payload to orchestration agent 806.

Orchestration agent 806 serves as a central decision-making hub for the architecture. Orchestration agent 806 can obtain the structured request payload from chatbot 804. To process the structured request payload, orchestration agent 806 can implement a machine learning model, such as a large language model, configured for semantic classification. Orchestration agent 806 parses the structured request payload to extract query parameters, user constraints, and historical conversational context. Orchestration agent 806 evaluates a semantic intent of the structured request payload using the large language model. Orchestration agent 806 compares the semantic intent against a predefined registry of available agents. Based on the semantic intent, orchestration agent 806 selects an appropriate execution agent from the predefined registry. For example, orchestration agent 806 may select insight agent 808 for structured data retrieval tasks or select data analysis agent 810 for data health assessments. Orchestration agent 806 generates a routing directive containing the extracted query parameters and the selection. Orchestration agent 806 outputs the routing directive to the selected execution agent to trigger downstream processing.

In instances where the semantic intent utilizes processing by multiple execution agents, the orchestration agent 806 can determine a sequence of execution by analyzing data dependencies among the required tasks. For example, if a natural language query requests both data retrieval and a quality assessment, the orchestration agent 806 determines that the quality assessment is strictly dependent upon the prior extraction of the data. To systematically establish this sequence, the orchestration agent 806 constructs a directed dependency graph that maps the required output payload of a first execution agent (e.g., the insight agent 808) as a required input parameter for a subsequent execution agent (e.g., the data analysis agent 810). Based on this dependency graph, the orchestration agent 806 generates an execution strategy that logically sequences the agents in chronological order. The orchestration agent 806 then routes the execution parameters according to this determined sequence, pausing downstream execution until the prerequisite upstream analytical results are returned.

This intent-based routing facilitates a technical improvement in the operational efficiency of the multi-agent system architecture 800. By dynamically mapping the semantic intent to specialized execution agents (e.g., insight agent 808 or data analysis agent 810), the orchestration agent 806 ensures that the relevant computational modules and data access paths are activated for a given query. This targeted activation reduces the overall processing load on the central backend coordinator and prevents the unnecessary execution of disparate machine learning models that do not correspond to the identified data domains. Furthermore, by isolating the execution strategies within specialized agents, the system minimizes memory contention and optimizes the context window utilized by the artificial intelligence reasoning engine 908. Consequently, the routing process represents a technical solution for managing distributed computational resources and maintaining high-throughput query resolution in complex data environments.

Insight agent 808 can execute data retrieval and analytics tasks corresponding to structured, semi-structured, and unstructured data domains. After receiving a routed request for data extraction from orchestration agent 806, insight agent 808 can translate natural language parameters into formal database syntax or unstructured search parameters. For structured and semi-structured domains, insight agent 808 can generate executable data queries formulated to extract specific information from underlying data stores and outputs these queries to data access agent 818.

Conversely, for unstructured data extraction, insight agent 808 can utilize a vectorization pipeline to perform semantic search operations. Specifically, an embedding model processes the routed request to generate a multi-dimensional numerical representation, or query vector, of the natural language parameters. Insight agent 808 can then transmit this query vector to data access agent 818 to query the unstructured data repositories. These repositories may comprise a vector database storing pre-computed document embeddings corresponding to raw text documents, portable document format files, or communication logs. The unstructured data repositories may include internal enterprise policy libraries and/or collaborative knowledge bases. By indexing these repositories, insight agent 808 may enable users to perform natural language retrieval of procedural documentation, compliance guidelines, and operational manuals. In this manner, the system may function as a unified interface for both quantitative database analysis and qualitative policy research.

Accordingly, data access agent 818 can execute a similarity algorithm, such as calculating a cosine similarity metric or performing a k-nearest neighbors search, to compare the query vector against the pre-computed document embeddings. To calculate the cosine similarity metric, data access agent 818 can compute the cosine of the angle between the query vector and a respective pre-computed document embedding. This is mathematically expressed as the dot product of the vectors divided by the product of their magnitudes:

$$Cosine Similarity = \frac{\sum ( {A}_{i} \times {B}_{i} )}{\sqrt{\sum {A}_{i}^{2}} \times \sqrt{\sum {B}_{i}^{2}}} ,$$

where Aᵢ and Bᵢ represent the corresponding vector components of the query vector and the document embedding. This geometric calculation normalizes the vectors, allowing data access agent 818 to accurately determine the semantic proximity between the natural language query and the unstructured data regardless of the overall length or word count of the underlying documents. Ultimately, retrieving unstructured data based on semantic proximity rather than exact keyword matching facilitates the discovery of contextually relevant information, even when the natural language parameters lack the specific terminology present in the underlying data stores. Data analysis agent 810 can assess the health and quality metrics of a data supply chain. After receiving analytical requests regarding data defects or metadata health from orchestration agent 806, data analysis agent 810 can evaluate these requests by formulating metadata queries that target data profiling statistics. These metadata queries are then output to data access agent 818. Upon obtaining the queried results, data analysis agent 810 generates corresponding health metrics, defect quantifications, and/or data profiling reports.

The defect quantifications generated by data analysis agent 810 can identify and categorize specific anomalies within the enterprise data supply chain. For example, data analysis agent 810 may identify data defects comprising null or missing values within mandatory database columns, formatting inconsistencies such as dates structured in conflicting formats, and referential integrity violations where foreign keys in a structured data source do not match corresponding primary keys. Additionally, data analysis agent 810 may detect duplicate records and anomalous data spikes that deviate from established historical baselines. By enumerating these specific data defects, data analysis agent 810 provides granular visibility into the reliability and accuracy of the underlying data stores.

Furthermore, data analysis agent 810 can execute a multi-hop lineage analysis to determine the cumulative health of a data asset, such as a regulatory report. Upon receiving a request from a report owner, data analysis agent 810 may identify the full sequence of upstream systems contributing to the report (e.g., System A providing data to System B, which feeds into System C). Data analysis agent 810 may then aggregate outstanding defects across all identified hops in the lineage path. This may allow the system to report not only the immediate defects in the final output but also the quantity of upstream errors in source systems that may impact the accuracy of a final report.

Data access agent 818 functions as a secure execution gateway to the underlying storage systems. In operation, data access agent 818 receives executable data queries from insight agent 808 and metadata queries from data analysis agent 810. Based on the target domains identified within these queries, data access agent 818 routes the executable data queries to structured data repository 820, as well as to semi-structured and unstructured data repositories (not explicitly illustrated in FIG. 8). Similarly, data access agent 818 routes the metadata queries to metadata repository 822. After extracting raw data payloads from these respective repositories, data access agent 818 returns the raw data payloads to insight agent 808 and data analysis agent 810 for final response formatting.

Structured data repository 820 and metadata repository 822 store enterprise or other information and may correspond to data catalogs generated by data ingestion processes described in connection with FIGS. 1-5. To populate structured data repository 820, automated data ingestion pipelines extract raw data from source systems, transform the raw data into structured formats, and load the structured formats into structured data repository 820. To populate metadata repository 822, metadata tagging operations analyze the raw data and generate descriptive metadata. The descriptive metadata includes data lineage mappings, data quality scores, and semantic definitions. The metadata tagging operations store the descriptive metadata within metadata repository 822. During query execution, structured data repository 820 and metadata repository 822 receive executable data queries and metadata queries from data access agent 818. Structured data repository 820 outputs queried data payloads to data access agent 818. Metadata repository 822 outputs queried metadata payloads to data access agent 818.

Security agent 814 enforces security conditions, enterprise access controls, and encryption protocols. After receiving a requested data payload and a user identity profile from orchestration agent 806, security agent 814 can extract role-based and attribute-based access control permissions from the user identity profile to enforce enterprise access controls. Furthermore, to protect data at rest, security agent 814 can apply encryption protocols to the requested data payload, such as Advanced Encryption Standard 256-bit encryption. Transmission channels may be concurrently secured using Transport Layer Security 1.3 to protect data in transit. Finally, security agent 814 can evaluate the user identity profile against the security conditions associated with a target data source and output an authorization determination indicating whether the user's access right satisfies these conditions.

While Advanced Encryption Standard 256-bit encryption provides a robust security posture, security agent 814 may alternatively or additionally implement other cryptographic protocols based on the classification of the data stored in structured data repository 820 or metadata repository 822. For example, security agent 814 may apply symmetric stream ciphers such as ChaCha20 for high-speed encryption operations, or asymmetric cryptographic algorithms such as Rivest-Shamir-Adleman or elliptic-curve cryptography for secure key exchange and payload protection. Furthermore, security agent 814 may implement format-preserving encryption techniques to maintain the original data formatting of the requested data payload while rendering the underlying sensitive information unintelligible to unauthorized users.

The security conditions may comprise an enumerated list of dynamic, attribute-based rules, including: (1) geographic fencing conditions ensuring the user identity profile indicates a physical location within the same jurisdiction as the structured data repository 820 to comply with data residency laws; (2) temporal restrictions limiting access to designated business hours; and (3) clearance level thresholds requiring a specific executive designation to access unmasked financial data. Security agent 814 can process these variables simultaneously to enforce a robust zero-trust architecture.

To enforce the clearance level thresholds, security agent 814 may compare a numeric tier assigned to the user identity profile against a corresponding numeric tier assigned to the target data source. For example, security agent 814 may implement a five-tier numerical framework wherein a level one threshold corresponds to public enterprise data, a level three threshold corresponds to internal proprietary data accessible by standard employees, and a level five threshold corresponds to highly restricted material, such as unmasked financial data or personally identifiable information, accessible only by executive leadership. Security agent 814 permits data extraction only when the numeric tier of the user identity profile meets or exceeds the required clearance level threshold of the requested data payload.

In some examples, the level one threshold corresponding to public enterprise data may include non-sensitive enterprise reference data, such as postal codes, state identifiers, and/or standard industry classification codes (e.g., NAICS codes). Because this reference data is publicly accessible outside the enterprise, security agent 814 may classify such reference data as “general user” data, allowing broad internal access without requiring elevated entitlements or specific business justifications. In this manner, the system may avoid unnecessarily restricting access to low-risk information assets while maintaining strict controls over sensitive customer profiles or other higher risk information assets.

Intake agent 812 manages an interactive workflow for elevated access requests. Intake agent 812 receives a failed authorization determination from security agent 814. To manage the interactive workflow, intake agent 812 initiates an interactive chat session via user interface 802. Intake agent 812 prompts a user to provide business justification for an elevated access right. Intake agent 812 captures the business justification. Intake agent 812 generates a formal request payload for the elevated access right. Intake agent 812 structures the business justification, a user identity profile, and a requested data payload into the formal request payload. Intake agent 812 routes the formal request payload to integration agent 824.

Integration agent 824 connects a multi-agent architecture to external enterprise workflows and fulfillment pipelines. Integration agent 824 obtains the formal request payload from intake agent 812. Integration agent 824 parses the formal request payload to determine an appropriate external routing path. Integration agent 824 generates application programming interface calls formatted for specific external enterprise infrastructure components and transmits the application programming interface calls to external systems to log, track, and route the elevated access request.

Ticketing system 826, entitlement system 828, and approval queue 830 represent the external enterprise infrastructure components. Ticketing system 826, entitlement system 828, and approval queue 830 receive the application programming interface calls and the formal request payload from integration agent 824. Ticketing system 826 generates support tickets based on the application programming interface calls. Entitlement system 828 evaluates user roles to provision the elevated access right. Approval queue 830 routes the elevated access request to a human manager for a manual review. Ticketing system 826, entitlement system 828, and approval queue 830 return status updates and final approval decisions to integration agent 824. Integration agent 824 monitors the status updates and the final approval decisions to trigger subsequent data access operations.

Audit agent 816 monitors and records interactions, prompts, and tool calls across a system. Audit agent 816 receives, retrieves, or otherwise obtains interaction logs, routing decisions, and data access events from orchestration agent 806. To track system compliance, audit agent 816 captures granular interaction metadata from the interaction logs. The granular interaction metadata comprises timestamps, user identification tokens, original natural language queries, and generated reasoning outputs. Audit agent 816 compiles the granular interaction metadata, the routing decisions, and the data access events into formatted compliance records. To ensure non-repudiation, audit agent 816 may apply a cryptographic hash to the formatted compliance records. More specifically, audit agent 816 may execute a Secure Hash Algorithm, such as SHA-256 or SHA-3, to generate a fixed-size 256-bit numerical string representing the exact state of the formatted compliance records at the time of the interaction. Furthermore, audit agent 816 may append a digital signature using an RSA-2048 or elliptic-curve cryptography (ECC) private key associated with the orchestration agent 806. Appending the digital signature facilitates rendering the cryptographic signature invalid upon any subsequent alteration of the logs stored in the audit log repository 832, thereby promoting forensic integrity. Audit agent 816 outputs the formatted compliance records and stores the formatted compliance records securely within audit log repository 832 to support enterprise governance and regulatory reviews.

Multi-agent system architecture 800 provides technical advantages over traditional monolithic data processing systems. By deploying particular execution agents, orchestration agent 806 reduces computational overhead and increases query resolution speed. Security agent 814 and intake agent 812 enforce strict enterprise data governance to prevent unauthorized data exfiltration. Furthermore, integration agent 824 eliminates manual context switching by automatically connecting conversational interfaces directly to external enterprise infrastructure components. Finally, audit agent 816 ensures comprehensive cryptographic traceability for all system interactions to satisfy rigorous regulatory compliance standards.

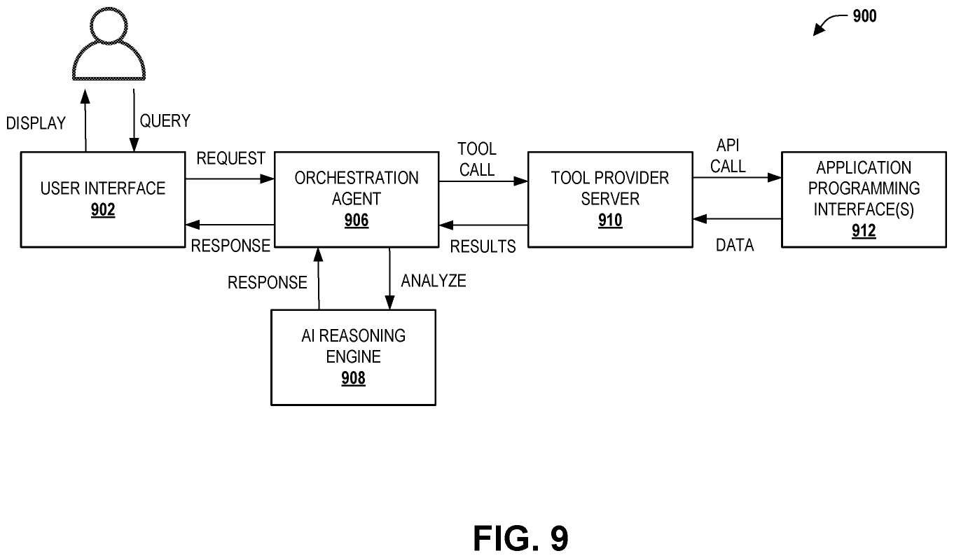

FIG. 9 illustrates an example technical flow and architecture 900 for implementing a conversational data exploration system. Technical flow 900 represents an underlying hardware and software stack that executes multi-agent system architecture 800 described in connection with FIG. 8. By executing multi-agent system architecture 800, technical flow 900 performs high-level data operations previously described in connection with FIG. 6 and FIG. 7. Technical flow 900 facilitates a forward request flow and a corresponding backward response flow to process complex data inquiries.

User interface 902 represents a presentation layer of technology stack 900. User interface 902 may utilize a React-based frontend framework and data-driven document libraries to facilitate interactive data exploration. A chatbot 804 within user interface 902 provides a conversational bridge between a user and multi-agent system architecture 800. User interface 902 receives an input comprising a user query, such as a typed natural language question or a voice command. User interface 902 captures the user query and extracts session metadata, the session metadata comprising a user identifier and a timestamp. User interface 902 generates a formatted request payload comprising the user query and the session metadata. User interface 902 transmits the formatted request payload to orchestration agent 806. After receiving a response from orchestration agent 806, chatbot 804 renders natural language explanations while the data-driven documents libraries generate dynamic visual representations of underlying data.

Orchestration agent 906 functions as a central backend coordinator. Orchestration agent 906 receives a formatted request payload from user interface 902. Orchestration agent 906 parses the formatted request payload to extract a user intent and session parameters. Orchestration agent 906 constructs a system prompt comprising the user intent, the session parameters, and an available tool schema. Orchestration agent 906 transmits an analysis request and the system prompt to artificial intelligence (AI) reasoning engine 908. Orchestration agent 906 receives a specified action from AI reasoning engine 908. Orchestration agent 906 transmits a formatted tool call to tool provider server 910 based on the specified action. Tool provider server 910 executes the formatted tool call to generate analytical results. Orchestration agent 906 receives the analytical results from tool provider server 910. Orchestration agent 906 transmits a context window comprising the analytical results to AI reasoning engine 908.

AI reasoning engine 908 can comprise a transformer-based large language model configured to interpret semantic intent and determine execution strategies. While described primarily as a transformer-based large language model, AI reasoning engine 908 may alternatively or additionally comprise other machine learning architectures. For example, AI reasoning engine 908 may implement a Retrieval-Augmented Generation (RAG) architecture to directly ground its reasoning in external, real-time knowledge bases prior to generating a response. Furthermore, AI reasoning engine 908 may employ a bidirectional encoder representations from transformers (BERT) model optimized for specialized natural language understanding, or an ensemble of task-specific neural networks to interpret the semantic intent. AI reasoning engine 908 can receive an analysis request from orchestration agent 906. The analysis request may comprise a conversational context, a user query, and a tool schema. To interpret the semantic intent, AI reasoning engine 908 can tokenize the user query and apply self-attention mechanisms to extract entity parameters. AI reasoning engine 908 maps the entity parameters to a tool schema to determine the execution strategies. For example, AI reasoning engine 908 may receive a user query comprising a request to “retrieve fourth quarter revenue for the European market.” AI reasoning engine 908 can tokenize the user query to extract a time parameter comprising “fourth quarter” and a location parameter comprising “European market.” AI reasoning engine 908 can then map the time parameter and the location parameter to a database query tool within the tool schema. Based on the execution strategies, AI reasoning engine 908 generates a reasoning response. The reasoning response comprises a structured data payload indicating specific tools or external systems required to handle the user query. Continuing the example, AI reasoning engine 908 can generate a reasoning response comprising a JavaScript Object Notation (JSON) payload formatted to execute the database query tool using the time parameter and the location parameter. AI reasoning engine 908 outputs the reasoning response to orchestration agent 906 to trigger subsequent operations.

In some examples, AI reasoning engine 908 may process complex cross-domain queries that involve joining reference data with proprietary customer data. For instance, if the user query requests, “How many small business customers with a NAICS code for ‘Corn Farming’ also hold a deposit account?” AI reasoning engine 908 may identify “Corn Farming” as a filter parameter for an enterprise reference database and “deposit account” as a selection parameter for a customer account database. The system may then generate an executable query that first retrieves a specific numerical code associated with the industry description from the reference data and may then use that numerical code to query the customer data, thereby bridging distinct data domains to generate an insight.

To facilitate the generation of the executable data query from the semantic meaning, AI reasoning engine 908 can implement a multi-stage mapping process. By way of example and not limitation, consider the following scenario. First, AI reasoning engine 908 tokenizes the natural language query to isolate specific entity parameters, such as temporal constraints, geographic identifiers, and metric definitions. Second, AI reasoning engine 908 evaluates these entity parameters against a registered schema of target data sources 32 to identify corresponding table names and column headers. Third, AI reasoning engine 908 applies a Text-to-SQL transformer model that utilizes a self-attention mechanism to determine the logical relationship between the isolated entities, for example, by identifying that a geographic identifier serves as a filter predicate (e.g., a “WHERE” clause) while a metric definition serves as a primary selection (e.g., a “SELECT” statement). This algorithmic transformation facilitates converting the semantic intent into a syntactically correct executable data query that is optimized for the specific architecture of the target data source.

Tool provider server 910 operates as a bridge component executing a model context protocol to connect orchestration agent 906 to external data. Tool provider server 910 receives a tool call from orchestration agent 906. The tool call may comprise a target function identifier and extracted execution parameters. To execute the model context protocol, tool provider server 910 can parse the tool call and map the target function identifier to a specific enterprise endpoint. Tool provider server 910 can then generate an application programming interface call using the extracted execution parameters. Tool provider server 910 can transmit the application programming interface call to the specific enterprise endpoint. In response, tool provider server 910 can obtain a raw data payload from the specific enterprise endpoint. Tool provider server 910 can normalize the raw data payload to generate formatted results. Tool provider server 910 transmits the formatted results back to orchestration agent 906 to supply external context for subsequent reasoning operations.

Application programming interface(s) 912 represent representational state transfer (REST) endpoints, GraphQL interfaces, or other enterprise data connections. Application programming interface(s) 912 can receive an application programming interface call from tool provider server 910 comprising a network protocol method, authorization headers, and a request body specifying required data objects or search parameters. Application programming interface(s) 912 can authenticate the application programming interface call using the authorization headers. After successful authentication, application programming interface(s) 912 can query an underlying data store to retrieve target information. Application programming interface(s) 912 can format the target information to generate raw data payloads formatted, for example, in JavaScript Object Notation (JSON) or Extensible Markup Language (XML). Application programming interface(s) 912 transmit the raw data payloads back to tool provider server 910 for integration into a final response flow.

Example technical flow and technology stack 900 provides technical advantages for conversational data exploration systems. By routing requests through orchestration agent 906, technology stack 900 decouples cognitive processing executed by artificial intelligence reasoning engine 908 from external data retrieval executed by tool provider server 910. Decoupling cognitive processing from external data retrieval isolates sensitive enterprise data stores connected to application programming interface(s) 912 and prevents unauthorized direct database access. Furthermore, executing the model context protocol within tool provider server 910 standardizes external data integration, reducing computational overhead and eliminating hardcoded endpoint dependencies. Additionally, the technical flow and technology stack 900 provides the advantage of decoupling prompt engineering from specific data retrieval logic. By utilizing the tool provider server 910 to execute the model context protocol, the orchestration agent 906 and AI reasoning engine 908 can remain agnostic to the underlying database schemas or API requirements of the application programming interface(s) 912. This decoupling allows for the updating or replacement of data sources without requiring a reconfiguration of the machine learning models or the system prompts, increasing system maintainability, and reducing the risk of model hallucinations caused by stale schema context. Within the presentation layer, generating dynamic visual representations using data-driven documents libraries allows user interface 902 to render complex analytical results natively. Native rendering conserves network bandwidth by avoiding transmissions of large, pre-rendered image files across a network.

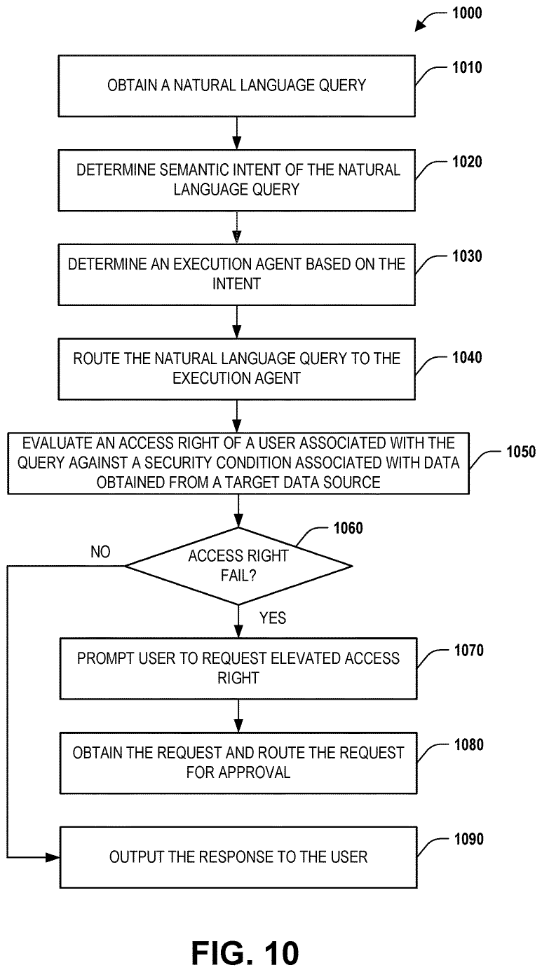

FIG. 10 illustrates an example method 1000 for processing a natural language query, evaluating access rights, and routing an access request. A computing system can execute method 1000. The computing system can comprise one or more processors, a memory, and a network interface. The memory stores computer-executable instructions. The one or more processors execute the computer-executable instructions to perform the operations of method 1000. The computing system can represent a single server, a cluster of servers, a cloud computing platform, or a distributed network architecture. By integrating intelligent routing and rigorous security gates, method 1000 protects sensitive information.

At block 1010, the computing system obtains a natural language query. The computing system captures text or voice inputs from a user via a frontend interface. The text or voice inputs comprise raw, unstructured alphanumeric characters. The computing system generates a digitized query payload based on the natural language query for semantic analysis.

At block 1020, the computing system determines a semantic intent of the natural language query. The computing system processes the digitized query payload using a machine learning model to parse conversational context and identify required data domains. The computing system outputs a computed intent score or a semantic classification corresponding to the natural language query.

At block 1030, the computing system determines an execution agent based on the semantic intent. The computing system maps the computed intent score or the semantic classification to a registry of specialized execution agents. The computing system outputs a selection of a specific execution agent, such as a data exploration agent, an insight agent, or a data analysis agent, optimized to handle the natural language query.

At block 1040, the computing system routes the natural language query to the specific execution agent. The computing system forwards operational parameters and the digitized query payload to the specific execution agent. The computing system generates a formatted task assignment to trigger data retrieval operations.

At block 1050, the computing system evaluates an access right of the user against a security condition associated with retrieved data obtained from a target data source. The computing system intercepts the retrieved data prior to user presentation. The computing system compares the retrieved data and a user identity profile against enterprise governance rules. The computing system outputs an authorization evaluation indicating a compliance status of the requested data operation.

At decision block 1060, the computing system determines whether the access right fails the security condition. The computing system analyzes the authorization evaluation. The computing system routes process flow to block 1070 after a failure condition and routes process flow to block 1090 after a success condition.

At block 1070, the computing system prompts the user to request an elevated access right. The computing system initiates an interactive approval workflow based on the failure condition. The computing system outputs a notification or a digital form to the user interface explaining an access restriction and requesting business justification for the elevated access right.

At block 1080, the computing system obtains the request and routes the request for approval. The computing system captures the business justification and interacts with external enterprise systems. The computing system outputs application programming interface calls to an external ticketing system or an approval queue to facilitate human-validated business review.

At block 1090, the computing system outputs a final response to the user. The computing system renders the retrieved data upon receiving the success condition. Alternatively, the computing system renders a status of the elevated access request. The computing system outputs a visual display comprising requested insights, generated charts, or workflow confirmation to the user.

Method 1000 provides technical advantages for secure data exploration. By dynamically routing the natural language query to a particular execution agent based on the semantic intent, the computing system minimizes processing overhead and conserves memory resources. The system further democratizes data access by implementing role-based semantic routing. Unlike traditional systems that require users to possess both data query skills and specific knowledge of which database houses relevant information, method 1000 utilizes the orchestration agent 906 and the security agent 814 to automatically determine the appropriate data domain based on the user's natural language intent and identity profile. This allows non-technical users to discover insights across siloed enterprise environments (e.g., structured data repository 820 and metadata repository 822) while the system automatically enforces compliance, thereby reducing the burden on specialized data analysts and accelerating the enterprise decision-making cycle. Furthermore, intercepting the retrieved data prior to user presentation establishes a system-level security perimeter. Intercepting the retrieved data prevents unauthorized data exposure and securely isolates restricted enterprise information. After detecting the failure condition, initiating the interactive approval workflow programmatically generates the application programming interface calls to external enterprise systems. Programmatically generating the application programming interface calls eliminates manual administrative delays and accelerates human-validated business reviews.

Note that FIG. 10 is just one example of a method, and other methods including fewer, additional, or alternative operations are possible consistent with this disclosure.

Aspects of the subject disclosure are rooted in a specific technical solution to the problem of managing and exploring fragmented enterprise data through a specialized multi-agent orchestration architecture. The techniques provide a significant improvement to computer functionality by dynamically allocating resources through an orchestration agent that interprets user intent to route queries to specialized execution agents. This architecture increases query resolution speed and reduces computational overhead, while the integration of a security agent establishes a system-level perimeter that intercepts data prior to presentation to enforce hardware-level security conditions. Furthermore, the system automates cross-system integration by programmatically generating application programming interface calls to bridge conversational interfaces directly with external infrastructure, thereby eliminating manual administrative delays and providing a concrete technical application that constitutes significantly more than a standard computer function.

### Example Clauses

Implementation examples are described in the following numbered clauses:

Clause 1: A method for accessing data, the method comprising obtaining a natural language query, invoking a computing system executing at least one machine learning model to analyze the natural language query to determine a semantic meaning, determine at least one target data source based on the semantic meaning, the at least one target data source including at least one of a structured data source or an unstructured data source, generate an executable data query in a data query language based on the at least one target data source and the semantic meaning, submit the executable data query to the at least one target data source, and generate a response to the natural language query, including integrating data obtained from the at least one target data source, and outputting the response.

Clause 2: The method of Clause 1, wherein invoking the computing system includes executing a multi-agent architecture comprising an orchestration agent and a plurality of execution agents.

Clause 3: The method of any of Clauses 1-2, wherein executing the multi-agent architecture includes interpreting, using the orchestration agent, an intent of the natural language query, and routing the natural language query to an execution agent of the plurality of execution agents based on the intent.

Clause 4: The method of any of Clauses 1-3, wherein the plurality of execution agents includes a data exploration agent and an unstructured data agent, and wherein routing the natural language query includes routing the natural language query to the data exploration agent based on the intent corresponding to a structured data source and routing the natural language query to the unstructured data agent based on the intent corresponding to an unstructured data source.

Clause 5: The method of any of Clauses 1-2, wherein the plurality of execution agents includes a data analysis agent, the method further comprising assessing, using the data analysis agent, a health of a data supply chain associated with the data obtained from the at least one target data source, including determining a quantity of outstanding defects associated with the data supply chain.

Clause 6: The method of any of Clauses 1-2, wherein the plurality of execution agents includes an audit agent, the method further comprising capturing, using the audit agent, an audit log of interactions across the multi-agent architecture.

Clause 7: The method of Clause 1, wherein outputting the response includes evaluating, using a security agent, an access right of a user associated with the natural language query against a security condition associated with the data obtained from the at least one target data source and outputting the response to the user based on the access right satisfying the security condition.

Clause 8: The method of Clause 1, further comprising evaluating, using a security agent, an access right of a user associated with the natural language query against a security condition associated with the data obtained from the at least one target data source, determining, using the security agent, the access right of the user fails to satisfy the security condition, prompting the user, using an intake agent, to request an elevated access right, obtaining a request for the elevated access right from the user, and routing the request for the elevated access right to an approval queue using an integration agent.

Clause 9: The method of Clause 1, wherein generating the response includes identifying sensitive data within the data obtained from the at least one target data source and replacing the sensitive data with fabricated data.

Clause 10: The method of Clause 1, wherein generating the response includes extracting an actionable insight from the data obtained from the at least one target data source, the actionable insight including a propensity score associated with a customer.

Clause 11: A system, comprising at least one processor implemented in circuitry and at least one memory coupled to the at least one processor that stores instructions that, when executed by the at least one processor, cause the system to obtain a natural language query, invoke at least one machine learning model to analyze the natural language query to determine a semantic meaning, determine at least one target data source based on the semantic meaning, the at least one target data source including at least one of a structured data source or an unstructured data source, generate an executable data query in a data query language based on the at least one target data source and the semantic meaning, submit the executable data query to the at least one target data source, and generate a response to the natural language query, including integrating data obtained from the at least one target data source, and output the response.

Clause 12: The system of Clause 11, wherein invoking the at least one machine learning model includes executing a multi-agent architecture comprising an orchestration agent and a plurality of execution agents.

Clause 13: The system of any of Clauses 11-12, wherein executing the multi-agent architecture includes interpreting, using the orchestration agent, an intent of the natural language query, and routing the natural language query to an execution agent of the plurality of execution agents based on the intent.

Clause 14: The system of any of Clauses 11-13, wherein the plurality of execution agents includes a data exploration agent and an unstructured data agent, and wherein routing the natural language query includes routing the natural language query to the data exploration agent based on the intent corresponding to a structured data source and routing the natural language query to the unstructured data agent based on the intent corresponding to an unstructured data source.

Clause 15: The system of any of Clauses 11-12, wherein the plurality of execution agents includes a data analysis agent, and wherein the instructions further cause the system to assess, using the data analysis agent, a health of a data supply chain associated with the data obtained from the at least one target data source, including determining a quantity of outstanding defects associated with the data supply chain.

Clause 16: The system of any of Clauses 11-12, wherein the plurality of execution agents includes an audit agent, and wherein the instructions further cause the system to capture, using the audit agent, an audit log of interactions across the multi-agent architecture.

Clause 17: The system of Clause 11, wherein to output the response, the instructions further cause the system to evaluate, using a security agent, an access right of a user associated with the natural language query against a security condition associated with the data obtained from the at least one target data source and output the response to the user based on the access right satisfying the security condition.

Clause 18: The system of Clause 11, wherein the instructions further cause the system to evaluate, using a security agent, an access right of a user associated with the natural language query against a security condition associated with the data obtained from the at least one target data source, determine, using the security agent, the access right of the user fails to satisfy the security condition, prompt the user, using an intake agent, to request an elevated access right, obtain a request for the elevated access right from the user, and route the request for the elevated access right to an approval queue using an integration agent.

Clause 19: The system of Clause 11, wherein to generate the response the instructions further cause the system to identify sensitive data within the data obtained from the at least one target data source and replace the sensitive data with fabricated data.

Clause 20: A computer-readable storage medium comprising instructions that, when executed by at least one processor, cause the at least one processor to perform a method, comprising obtaining a natural language query, invoking at least one machine learning model to analyze the natural language query to determine a semantic meaning, determine at least one target data source based on the semantic meaning, the at least one target data source including at least one of a structured data source or an unstructured data source, generate an executable data query in a data query language based on the at least one target data source and the semantic meaning, submit the executable data query to the at least one target data source, and generate a response to the natural language query, including integrating data obtained from the at least one target data source, and outputting the response.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented, or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database, or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed:

1. A method for accessing data, the method comprising:
obtaining a natural language query;
invoking a computing system executing at least one machine learning model to:
analyze the natural language query to determine a semantic meaning;
determine at least one target data source based on the semantic meaning, the at least one target data source including at least one of a structured data source or an unstructured data source;
generate an executable data query in a data query language based on the at least one target data source and the semantic meaning;
submit the executable data query to the at least one target data source; and
generate a response to the natural language query, including integrating data obtained from the at least one target data source; and
outputting the response.

2. The method of claim 1, wherein invoking the computing system includes executing a multi-agent architecture comprising an orchestration agent and a plurality of execution agents.

3. The method of claim 2, wherein executing the multi-agent architecture includes:
interpreting, using the orchestration agent, a semantic intent of the natural language query;
determining an execution strategy comprising a selection of multiple execution agents from the plurality of execution agents and a sequence of execution based on the semantic intent;
routing execution parameters to the multiple execution agents according to the sequence of execution; and
combining analytical results returned from the multiple execution agents to formulate the response.

4. The method of claim 3, wherein outputting the response includes:
intercepting, using the orchestration agent, the data obtained from the at least one target data source prior to user presentation;
transmitting the data and a user identity profile associated with a user from the orchestration agent to a security agent;
evaluating, using the security agent, an access right extracted from the user identity profile against a real-time security condition associated with the data; and
outputting the response to the user based on the access right satisfying the real-time security condition.

5. The method of claim 3, wherein the plurality of execution agents includes an insight agent and a data analysis agent, and wherein routing the execution parameters includes:
routing the execution parameters to the insight agent based on the semantic intent corresponding to a data extraction task; and
routing the execution parameters to the data analysis agent based on the semantic intent corresponding to a data health assessment.

6. The method of claim 3, wherein the plurality of execution agents includes a data analysis agent, the method further comprising assessing, using the data analysis agent, a health of a data supply chain associated with the data obtained from the at least one target data source, including determining a quantity of outstanding defects associated with the data supply chain.

7. The method of claim 3, further comprising:
intercepting, using the orchestration agent, the data obtained from the at least one target data source prior to user presentation;
transmitting the data and a user identity profile associated with a user from the orchestration agent to a security agent;
evaluating, using the security agent, an access right extracted from the user identity profile against a security condition associated with the data;
determining, using the security agent, the access right of the user fails to satisfy the security condition;
prompting the user, using an intake agent, to request an elevated access right;
obtaining a request for the elevated access right from the user; and
routing the request for the elevated access right to an approval queue using an integration agent.

8. The method of claim 2, wherein the plurality of execution agents includes an audit agent, the method further comprising capturing, using the audit agent, an audit log of interactions across the multi-agent architecture.

9. The method of claim 1, wherein generating the response includes:
identifying sensitive data within the data obtained from the at least one target data source; and
replacing the sensitive data with fabricated data.

10. The method of claim 1, wherein generating the response includes extracting an actionable insight from the data obtained from the at least one target data source, the actionable insight including a propensity score associated with a customer.

11. A system, comprising:
at least one processor implemented in circuitry; and
at least one memory coupled to the at least one processor that stores instructions that, when executed by the at least one processor, cause the system to:
obtain a natural language query;
invoke at least one machine learning model to:
analyze the natural language query to determine a semantic meaning;
determine at least one target data source based on the semantic meaning, the at least one target data source including at least one of a structured data source or an unstructured data source;
generate an executable data query in a data query language based on the at least one target data source and the semantic meaning;
submit the executable data query to the at least one target data source; and
generate a response to the natural language query, including integrating data obtained from the at least one target data source; and
output the response.

12. The system of claim 11, wherein invoking the at least one machine learning model includes executing a multi-agent architecture comprising an orchestration agent and a plurality of execution agents.

13. The system of claim 12, wherein to execute the multi-agent architecture, the instructions further cause the system to:
interpret, using the orchestration agent, a semantic intent of the natural language query; determine an execution strategy comprising a selection of multiple execution agents from the plurality of execution agents and a sequence of execution based on the semantic intent;
route execution parameters to the multiple execution agents according to the sequence of execution; and
combine analytical results returned from the multiple execution agents to formulate the response.

14. The system of claim 13, wherein to output the response, the instructions further cause the system to:
intercept, using the orchestration agent, the data obtained from the at least one target data source prior to user presentation;
transmit the data and a user identity profile associated with a user from the orchestration agent to a security agent; evaluate, using the security agent, an access right extracted from the user identity profile against a real-time security condition associated with the data; and
output the response to the user based on the access right satisfying the real-time security condition.

15. The system of claim 13, wherein the plurality of execution agents includes an insight agent and a data analysis agent, and wherein to route the execution parameters, the instructions further cause the system to:
route the execution parameters to the insight agent based on the semantic intent corresponding to a data extraction task; and
route the execution parameters to the data analysis agent based on the semantic intent corresponding to a data health assessment.

16. The system of claim 13, wherein the instructions further cause the system to:
intercept, using the orchestration agent, the data obtained from the at least one target data source prior to user presentation;
transmit the data and a user identity profile associated with a user from the orchestration agent to a security agent; evaluate, using the security agent, an access right extracted from the user identity profile against a security condition associated with the data;
determine, using the security agent, the access right of the user fails to satisfy the security condition;
prompt the user, using an intake agent, to request an elevated access right;
obtain a request for the elevated access right from the user; and
route the request for the elevated access right to an approval queue using an integration agent.

17. The system of claim 12, wherein the plurality of execution agents includes a data analysis agent, and wherein the instructions further cause the system to assess, using the data analysis agent, a health of a data supply chain associated with the data obtained from the at least one target data source, including determining a quantity of outstanding defects associated with the data supply chain.

18. The system of claim 12, wherein the plurality of execution agents includes an audit agent, and wherein the instructions further cause the system to capture, using the audit agent, an audit log of interactions across the multi-agent architecture.

19. The system of claim 11, wherein to generate the response the instructions further cause the system to:
identify sensitive data within the data obtained from the at least one target data source; and
replace the sensitive data with fabricated data.

20. A computer-readable storage medium comprising instructions that, when executed by at least one processor, cause the at least one processor to:
obtain a natural language query;
invoke at least one machine learning model to:
analyze the natural language query to determine a semantic meaning;
determine at least one target data source based on the semantic meaning, the at least one target data source including at least one of a structured data source or an unstructured data source;
generate an executable data query in a data query language based on the at least one target data source and the semantic meaning;
submit the executable data query to the at least one target data source; and
generate a response to the natural language query, including integrating data obtained from the at least one target data source; and
output the response.
